(19) United States
(12) Patent Application Publication
(10) Pub. No.: US 2026/0205234 A1
(43) Pub. Date: Jul. 16, 2026

(54) TECHNIQUES FOR PRIORITY HANDLING FOR SIMULTANEOUS PHYSICAL SIDELINK FEEDBACK CHANNELS IN SIDELINK UNLICENSED

(71) Applicant: QUALCOMM Incorporated, San Diego, CA (US)

(72) Inventors: Shaozhen GUO, Beijing (CN); Changlong XU, Beijing (CN); Jing SUN, San Diego, CA (US); Xiaoxia ZHANG, San Diego, CA (US); Luanxia YANG, Beijing (CN); Siyi CHEN, Beijing (CN); Chih-Hao LIU, San Diego, CA (US); Giovanni CHISCI, San Diego, CA (US)

(21) Appl. No.: 19/137,819

(22) PCT Filed: Feb. 7, 2023
(86) PCT No.: PCT/CN2023/074755

§ 371 Date: Jun. 11, 2025

(51) Int. Cl. H04L 1/1829; H04W 16/14; H04W 92/18

(52) U.S. Cl. CPC H04L 1/1854; H04W 16/14; H04W 92/18

(57) ABSTRACT

Various aspects of the present disclosure generally relate to wireless communication. In some aspects, a responding user equipment (UE) may receive, over an unlicensed sidelink channel, multiple physical sidelink shared channel (PSSCH) transmissions associated with a physical sidelink feedback channel (PSFCH) transmission occasion, wherein at least one PSFCH transmission in the PSFCH transmission occasion is in a shared channel occupancy time (COT). The UE may determine a minimum number of PSFCH transmissions to transmit in the PSFCH transmission occasion. The UE may select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The UE may transmit, over the unlicensed sidelink channel, the selected set of PSFCH transmissions in the PSFCH transmission occasion. Numerous other aspects are described.

### FIELD OF THE DISCLOSURE

Aspects of the present disclosure generally relate to wireless communication and to techniques and apparatuses associated with priority handling for simultaneous physical sidelink feedback channels (PSFCHs) in sidelink unlicensed (SL-U).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a responding user equipment (UE). The method may include receiving, over an unlicensed sidelink channel, multiple physical sidelink shared channel (PSSCH) transmissions associated with a physical sidelink feedback channel (PSFCH) transmission occasion, wherein at least one PSFCH transmission in the PSFCH transmission occasion is in a shared channel occupancy time (COT). The method may include determining a minimum number of PSFCH transmissions to transmit in the PSFCH transmission occasion. The method may include selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The method may include transmitting, over the unlicensed sidelink channel, the selected set of PSFCH transmissions in the PSFCH transmission occasion.

Some aspects described herein relate to a responding UE for wireless communication. The responding UE may include a memory and one or more processors coupled to the memory. The one or more processors may be configured to receive, over an unlicensed sidelink channel, multiple PSSCH transmissions associated with a PSFCH transmission occasion, wherein at least one PSFCH transmission in the PSFCH transmission occasion is in a shared COT. The one or more processors may be configured to determine a minimum number of PSFCH transmissions to transmit in the PSFCH transmission occasion. The one or more processors may be configured to select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The one or more processors may be configured to transmit, over the unlicensed sidelink channel, the selected set of PSFCH transmissions in the PSFCH transmission occasion.

Some aspects described herein relate to a non-transitory computer-readable

medium that stores a set of instructions for wireless communication by a responding UE. The set of instructions, when executed by one or more processors of the UE, may cause the UE to receive, over an unlicensed sidelink channel, multiple PSSCH transmissions associated with a PSFCH transmission occasion, wherein at least one PSFCH transmission in the PSFCH transmission occasion is in a shared COT. The set of instructions, when executed by one or more processors of the UE, may cause the UE to determine a minimum number of PSFCH transmissions to transmit in the PSFCH transmission occasion. The set of instructions, when executed by one or more processors of the UE, may cause the UE to select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The set of instructions, when executed by one or more processors of the UE, may cause the UE to transmit, over the unlicensed sidelink channel, the selected set of PSFCH transmissions in the PSFCH transmission occasion.

Some aspects described herein relate to an apparatus for wireless communication. The apparatus may include means for receiving, over an unlicensed sidelink channel, multiple PSSCH transmissions associated with a PSFCH transmission occasion, wherein at least one PSFCH transmission in the PSFCH transmission occasion is in a shared COT. The apparatus may include means for determining a minimum number of PSFCH transmissions to transmit in the PSFCH transmission occasion. The apparatus may include means for selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The apparatus may include means for transmitting, over the unlicensed sidelink channel, the selected set of PSFCH transmissions in the PSFCH transmission occasion.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of resources associated with a physical sidelink feedback channel (PSFCH), in accordance with the present disclosure.

FIG. 6 is a diagram illustrating an example of channel occupancy time (COT) sharing for sidelink unlicensed (SL-U), in accordance with the present disclosure.

FIG. 7 is a diagram illustrating an example of multiple PSFCH transmissions using a shared COT in SL-U, in accordance with the present disclosure.

FIG. 8 is a diagram illustrating an example associated with selecting a number of PSFCH transmissions to transmit in a PSFCH transmission occasion when using a shared COT in SL-U, in accordance with the present disclosure.

FIGS. 9A-9B are diagrams illustrating examples associated with selecting PSFCH transmissions to transmit in a PSFCH transmission occasion when using a shared COT in SL-U, in accordance with the present disclosure.

FIG. 10 is a diagram illustrating an example process associated with priority handling for simultaneous PSFCHs in SL-U, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

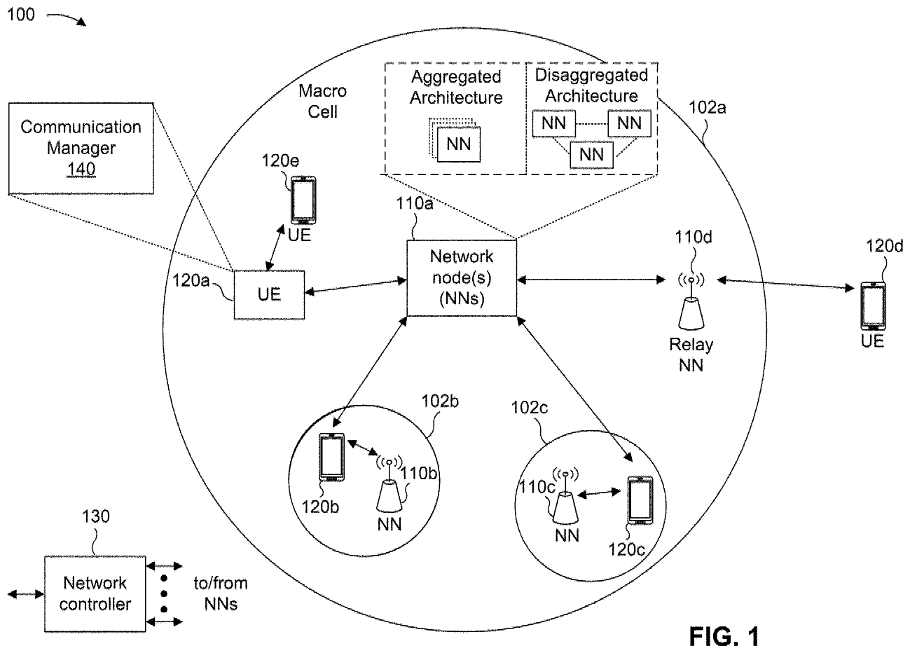

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, over an unlicensed sidelink channel, multiple physical sidelink shared channel (PSSCH) transmissions associated with a physical sidelink feedback channel (PSFCH) transmission occasion, wherein at least one PSFCH transmission in the PSFCH transmission occasion is in a shared channel occupancy time (COT); determine a minimum number of PSFCH transmissions to transmit in the PSFCH transmission occasion; select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT; and transmit, over the unlicensed sidelink channel, the selected set of PSFCH transmissions in the PSFCH transmission occasion. Additionally, or alternatively, the communication manager 140 may perform one or more other operations described herein.

As indicated above, FIG. 1 is provided as an example. Other examples may differ from what is described with regard to FIG. 1.

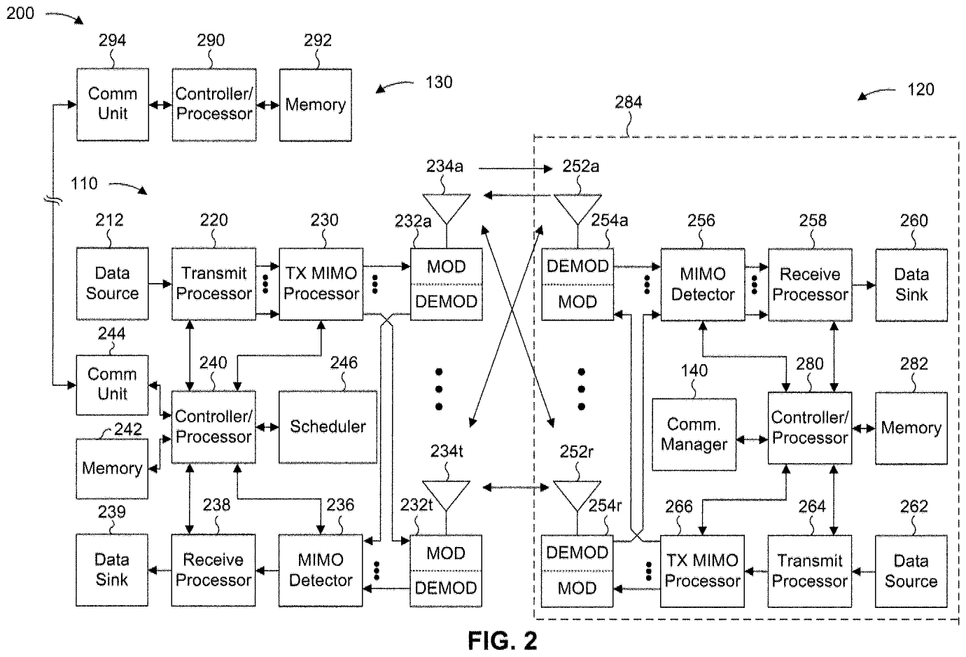

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

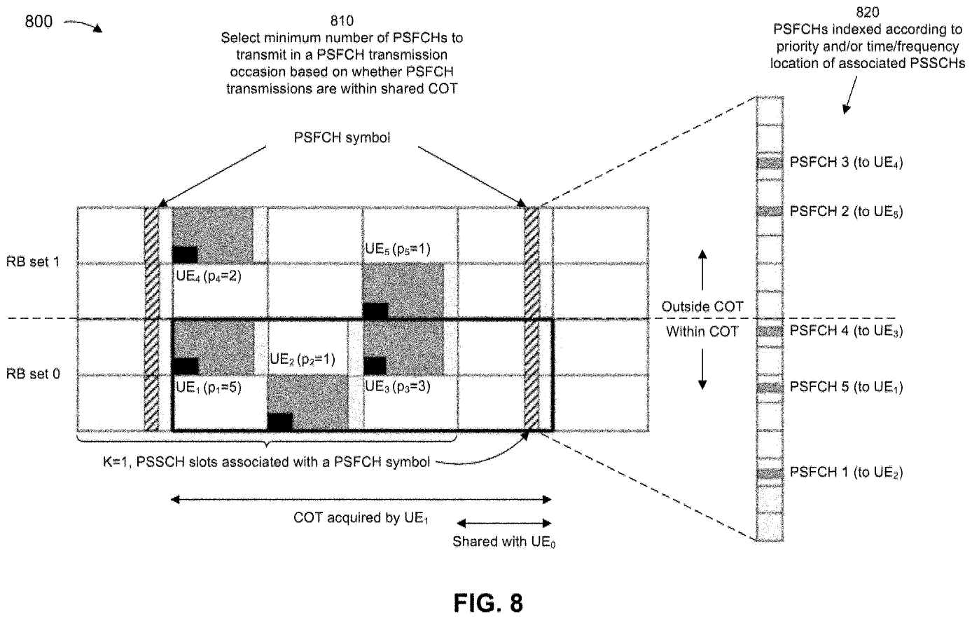

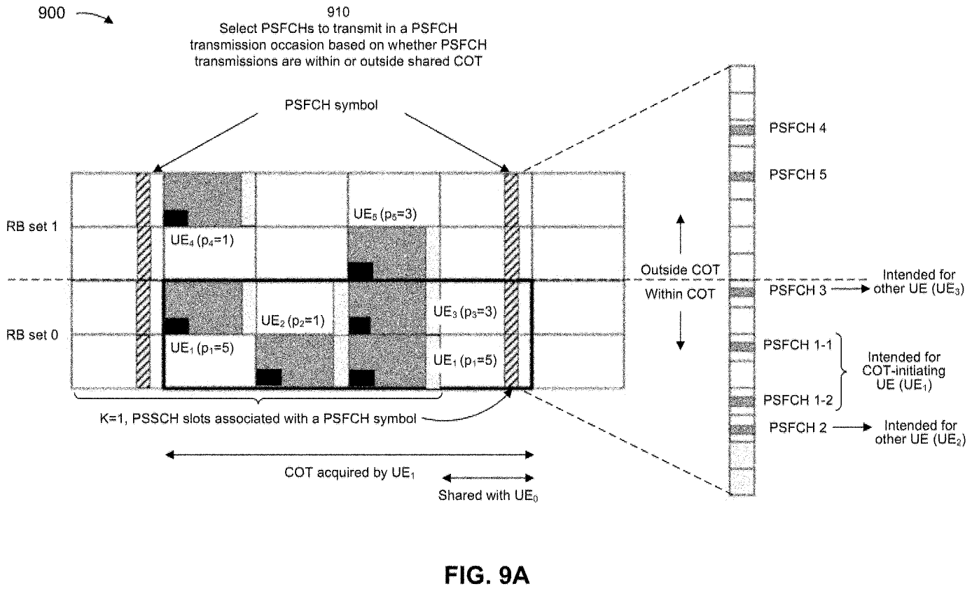

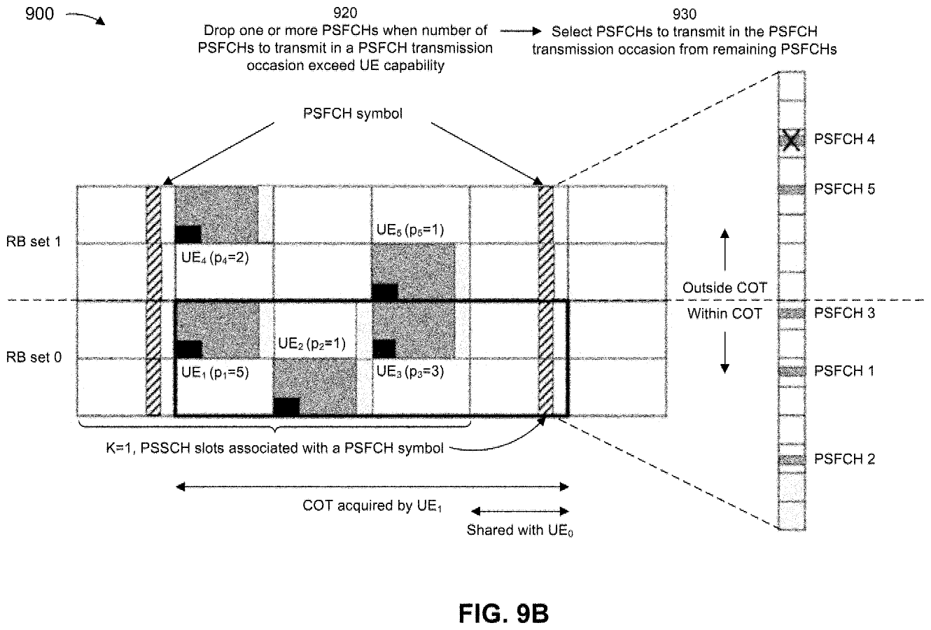

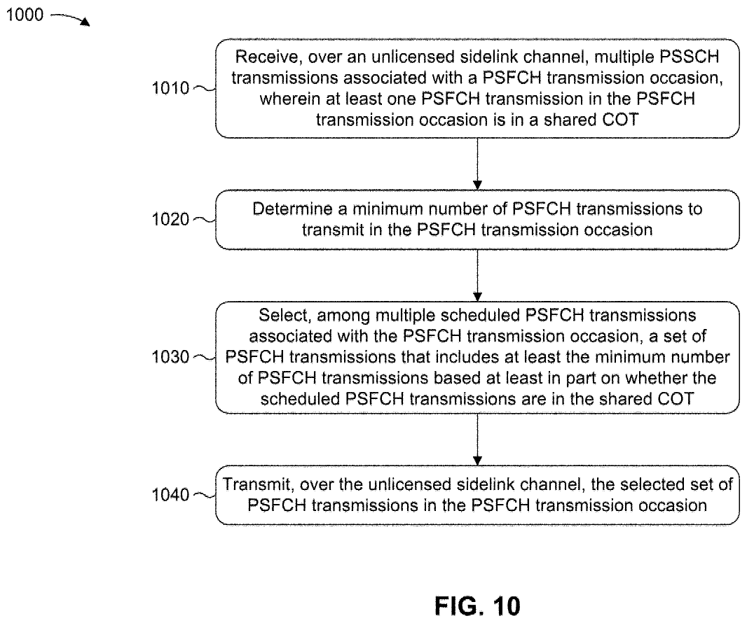

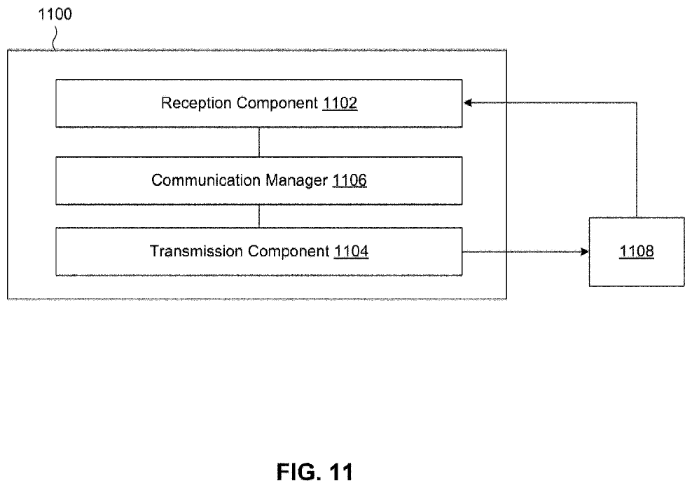

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIG. 8, FIGS. 9A-9B, FIG. 10, and/or FIG. 11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIG. 8, FIGS. 9A-9B, FIG. 10, and/or FIG. 11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

The controller/processor 240 of the network node 110, the controller/processor 280 of the UE 120, or any other component(s) of FIG. 2 may perform one or more techniques associated with priority handling for simultaneous PSFCHs in sidelink unlicensed (SL-U), as described in more detail elsewhere herein. For example, the controller/processor 240 of the network node 110, the controller/processor 280 of the UE 120, or any other component(s) (or combinations of components) of FIG. 2 may perform or direct operations of, for example, process 10 of FIG. 10 and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10 and/or other processes as described herein. In some examples, executing instructions may include running the instructions, converting the instructions, compiling the instructions, and/or interpreting the instructions, among other examples.

In some aspects, a responding UE 120 includes means for receiving, over an unlicensed sidelink channel, multiple PSSCH transmissions associated with a PSFCH transmission occasion, wherein at least one PSFCH transmission in the PSFCH transmission occasion is in a shared COT; means for determining a minimum number of PSFCH transmissions to transmit in the PSFCH transmission occasion; means for selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT; and/or means for transmitting, over the unlicensed sidelink channel, the selected set of PSFCH transmissions in the PSFCH transmission occasion. The means for the responding UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

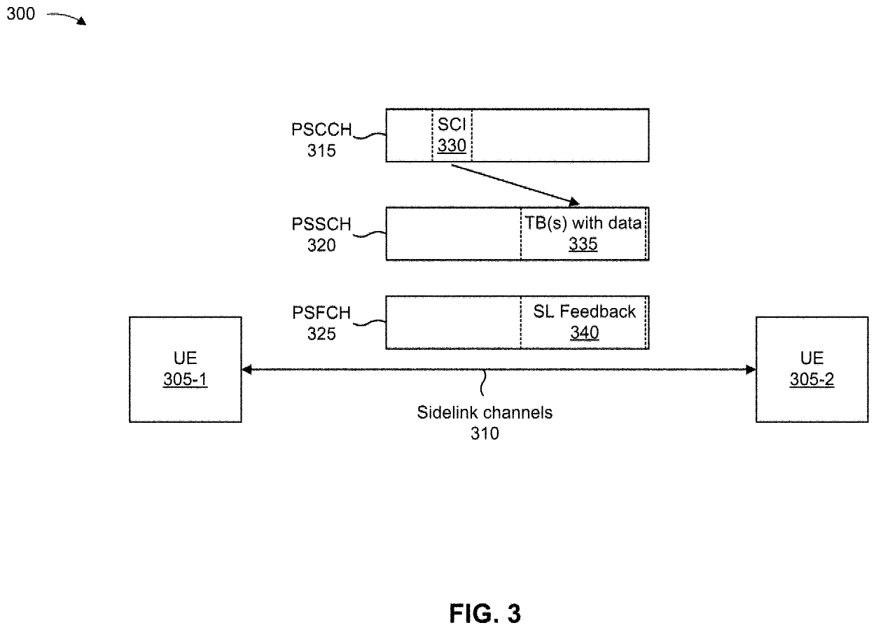

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a PSSCH 320, and/or a PSFCH 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of RBs that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with regard to FIG. 3.

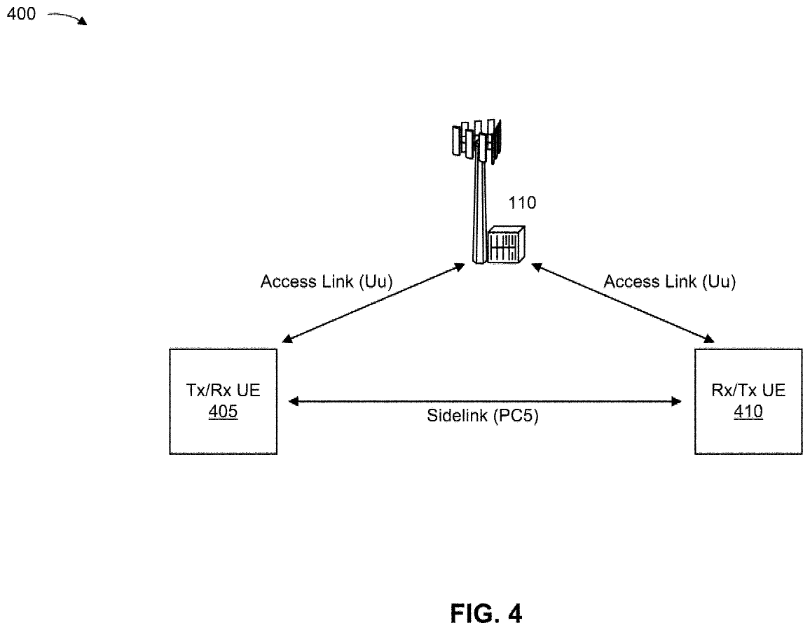

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with regard to FIG. 4.

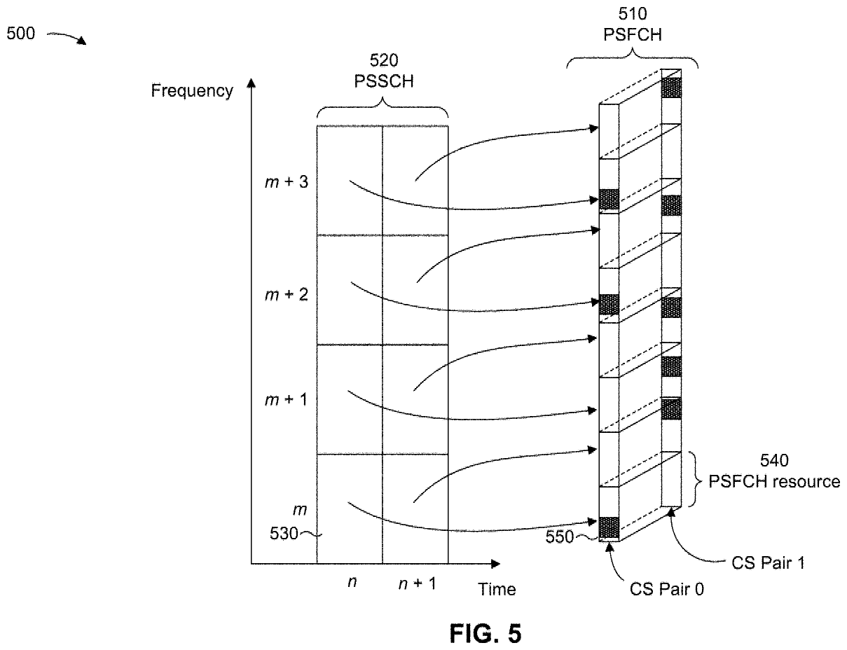

FIG. 5 is a diagram illustrating an example 500 of resources associated with a PSFCH 510, in accordance with the present disclosure. As described herein, the resources shown in example 500 may be associated with sidelink communications, such as the sidelink communications described in connection with FIG. 3 and FIG. 4. For example, the resources shown in example 500 and described herein may be associated with sidelink communications between and/or among multiple UEs (e.g., UE 120, UE 305-1, UE 305-2, Tx/Rx UE 405, and/or Rx/Tx UE 410, among other examples). Additionally, or alternatively, the PSFCH 510 shown in FIG. 5 and described herein may correspond to the PSFCH 325 described in connection with FIG. 3.

In some aspects, the PSFCH 510 may be associated with (e.g., be used to carry or otherwise provide HARQ feedback related to) a PSSCH 520, which may correspond to the PSSCH 320 described in connection with FIG. 3. For example, in some aspects, the HARQ feedback may include an ACK to indicate that a responding UE successfully received and decoded a PSSCH message transmitted on the PSSCH 520, or a NACK to indicate that the responding UE failed to receive or failed to decode a PSSCH message transmitted on the PSSCH 520. Additionally, or alternatively, the PSFCH 510 may be used to carry conflict information associated with a PSSCH message transmitted on the PSSCH 520 (e.g., indicating a resource conflict for a resource that is reserved for an upcoming transmission on the PSSCH 520 and/or a resource conflict for a transmission that has already occurred on the PSSCH 520).

The PSSCH 520 may be associated with a set of PSSCH occasions 530, which may be present across a resource grid associated with slots n and n+1 and subchannels m, m+1, m+2, and m+3. Each PSSCH occasion 530 may correspond to a different PSFCH resource 540 associated with the PSFCH 510. For example, for a PSSCH communication received in slot n and subchannel m, a responding UE may transmit HARQ feedback information 550 over multiple physical resource blocks (PRBs) within a corresponding PSFCH resource 540, as shown by the arrow connecting the PSSCH occasion 530 associated with slot n and subchannel m with the PSFCH resource 540 including the HARQ feedback information 550. Similarly, the other PSSCH occasions 530 may each be associated with a corresponding PSFCH resource 540. In some cases, for each PSFCH resource 540, a responding UE may use multiple length-12 sequence repetitions across multiple PRBs and/or may use different cyclic shift (CS) pairs (e.g., CS pair 0 and CS pair 1) to differentiate between an ACK or a NACK for each sequence.

In some instances, resources associated with the PSFCH 510 may be associated with a resource pool, which is not a dedicated PSFCH resource pool in example 500. Instead, in example 500, the resource pool associated with the PSFCH 510 includes resources for multiple sidelink communication types (e.g., different sidelink channels), such as PSSCH communications and/or PSCCH communications in addition to PSFCH communications. In such cases, the responding UE providing the HARQ feedback information 550 may be configured with one or more parameters to determine the PSFCH 510 and/or a specific PSFCH resource 540 to use to transmit the HARQ feedback information 550. For example, the responding UE may receive an indication of a PSFCH period parameter (e.g., a periodPSFCHresource parameter), which may indicate a period (in a number of slots) within a resource pool for a PSFCH transmission. In some cases, the PSFCH period parameter may have a value equal to zero (0), which may indicate that there is no PSFCH, or the PSFCH period parameter may have a value of one slot, two slots, or four slots. For a given PSSCH 520, the responding UE may then transmit the HARQ feedback information 550 (e.g., ACK/NACK information) in a first slot associated with a PSFCH resource 540 after the PSSCH 520 and following a minimum time gap, which may be indicated by a PSFCH minimum time gap parameter (e.g., a minTimeGapPSFCH parameter).

Additionally, or alternatively, a responding UE may receive an indication of a set of PRBs within a slot that are used for PSFCH transmission and reception (e.g., denoted

$${M}_{PRB , set}^{PSFCH}$$

and/or indicated in an sl-PSFCH-RB-Set parameter). Accordingly, each PSSCH occasion 530 may be associated with a number of PRBs, which may be a subset of

$${M}_{PRB , set}^{PSFCH} .$$

More particularly, a PSSCH 520 may be associated with a number of slots associated with one PSFCH 510 slot (e.g., denoted

$${N}_{PSSCH}^{PSFCH} ,$$

which, in example 500, is equal to two (2), corresponding to slot n and slot n+1), and/or a PSSCH 520 may be associated with a number of subchannels within each slot (e.g., denoted

$${N}_{subch}^{PSSCH} ,$$

which, in example 500, is equal to four (4), corresponding to subchannels m, m+1, m+2, and m+3). In such cases, each subchannel and/or slot of the PSSCH 520 resource grid (e.g., each PSSCH occasion 530) may be associated with a number of PSFCH PRBs

$$( e . g . , denoted {M}_{subch , slot}^{PSFCH} )$$

for PSFCH transmission and reception, which may be equal to

$$\frac{{M}_{PRB , set}^{PSFCH}}{{N}_{PSSCH}^{PSFCH} \times {N}_{subch}} PRBs .$$

A mapping between each subchannel and/or slot of the PSSCH 520 resource grid (e.g., each PSSCH occasion 530) and a corresponding PSFCH resource 540 may be performed in a time-first manner, as shown using arrows in FIG. 5. For example, a first-in-time PSSCH occasion 530 (e.g., a PSSCH occasion 530 in slot n) in a first subchannel (e.g., subchannel m) may be mapped to a first PSFCH resource 540, a second-in-time PSSCH occasion 530 in a first subchannel may be mapped to a second PSFCH resource 540, a first-in-time PSSCH occasion 530 in a second subchannel may be mapped to a third PSFCH resource 540, and so forth.

In some cases a size of a PSFCH resource pool

$$( e . g . , denoted {R}_{P RB , CS}^{PSFCH} ) ,$$

may be equal to

$${N}_{type}^{PSFCH} \times {N}_{CS}^{PSFCH} \times {M}_{s u bch , slot}^{PSFCH} .$$

In such cases,

$${N}_{type}^{PSFCH}$$

may be based at least in part on whether the PSFCH resource pool is associated with multiple subchannels in a PSSCH slot. For example,

$${N}_{type}^{PSFCH}$$

may be equal to one (1) if the PSFCH resource pool is only associated with one PSSCH subchannel, or may otherwise equal the number of subchannels within each PSSCH slot

$$( e . g . , {N}_{subch}^{PSSCH} ) .$$

Furthermore, the term

$${N}_{CS}^{PSFCH}$$

may correspond to a number of cyclic shift pairs associated with the PSFCH resource pool, which may be configured per resource pool, and the term

$${M}_{subch , slot}^{PSFCH}$$

may correspond to the number of PSFCH PRBs associated with each subchannel and/or slot of the PSSCH 520 resource grid (e.g., each PSSCH occasion 530), as described above. Additionally, or alternatively, a responding UE may determine a PSFCH resource according to the formula

$$( {P}_{ID} + {M}_{ID} ) mod {R}_{PRBCS}^{PSFCH} ,$$

where

$${R}_{PRB , CS}^{PSFCH}$$

corresponds to the size of the PSFCH resource pool (as described above), P_{ID} corresponds to a physical source identifier indicated by an SCI message (e.g., SCI-2A or SCI-2B) associated with the PSSCH 520, and M_{ID} is either zero (0) or corresponds to an identity of the responding UE receiving the PSSCH 520. In other words, for a unicast transmission, M_{ID} may be equal to zero (0) and the responding UE may provide feedback in a PSFCH resource pool that depends only on a source identifier (e.g., P_{ID}), and for a groupcast transmission, each receiving UE may pick a separate resource in the resource pool for transmitting feedback, which is dependent on both P_{ID} and M_{ID}.

As indicated above, FIG. 5 is provided as an example. Other examples may differ from what is described with regard to FIG. 5.

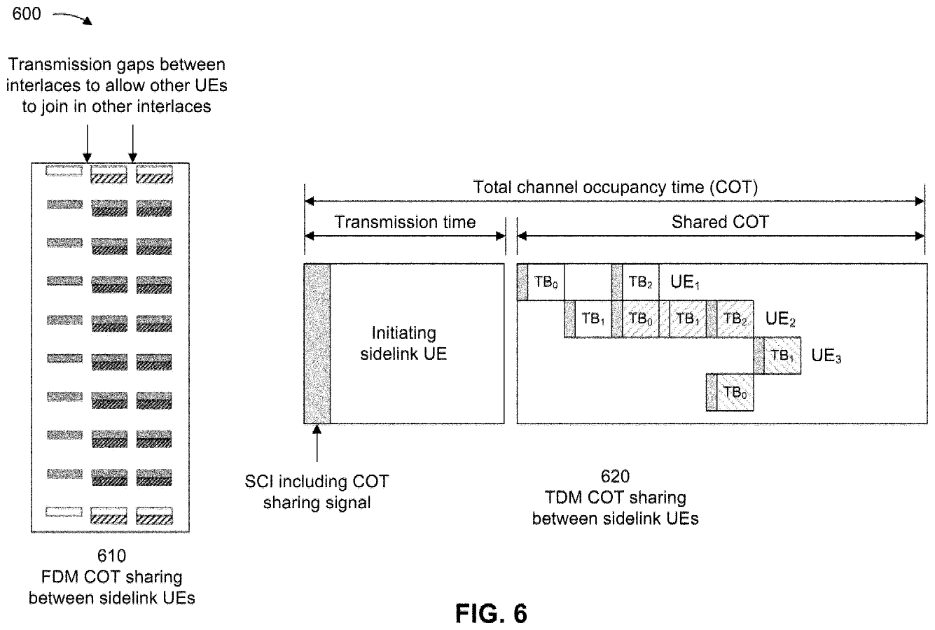

FIG. 6 is a diagram illustrating an example 600 of COT sharing for SL-U, in accordance with the present disclosure.

To accommodate increasing traffic demands, there have been various efforts to improve spectral efficiency in wireless networks and thereby increase network capacity (e.g., via use of higher order modulations, advanced MIMO antenna technologies, and/or multi-cell coordination techniques, among other examples). Another way to potentially improve network capacity is to expand system bandwidth. However, available spectrum in lower frequency bands that have traditionally been licensed or otherwise allocated to mobile network operators has become very scarce. Accordingly, various technologies have been developed to enable operation of a cellular RAT in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, NR-U enables NR operation in unlicensed spectrum, and SL-U enables sidelink operation in unlicensed spectrum. In general, when operating a cellular RAT in unlicensed spectrum (e.g., using LAA, eLAA, feLAA, MulteFire, NR-U, and/or SL-U), one challenge that arises is the need to ensure fair coexistence with incumbent (e.g., WLAN) systems that may be operating in the unlicensed spectrum.

For example, prior to gaining access to and/or transmitting over an unlicensed channel, a transmitting device (e.g., a network node 110, a UE 120, or the like) that has a packet to transmit may need to perform a listen-before-talk (LBT) procedure to contend for access to the unlicensed channel. The LBT procedure may generally include a clear channel assessment (CCA) procedure that is performed in order to determine whether the unlicensed channel is available (e.g., unoccupied by other transmitters). In particular, the CCA procedure may include detecting an energy level on the unlicensed channel and determining whether the energy level satisfies (e.g., is less than or equal to) a threshold, sometimes referred to as an energy detection threshold (EDT). When the energy level satisfies (e.g., does not equal or exceed) the threshold, the CCA procedure is deemed to be successful and the transmitting device may gain access to the unlicensed channel for a duration that may be referred to as a COT, during which the transmitting device can perform transmissions without performing additional LBT operations. When the energy level does not satisfy the threshold, the CCA procedure is unsuccessful and contention to access the unlicensed channel may be deemed unsuccessful.

When the CCA procedure results in a determination that the unlicensed channel band is unavailable (e.g., because the energy level detected on the unlicensed channel indicates that another device is already using the channel), the CCA procedure may be performed again at a later time. In environments in which the transmitting device may be starved of access to an unlicensed channel (e.g., due to WLAN activity or transmissions by other devices), an extended CCA (eCCA) procedure may be employed to increase the likelihood that the transmitting device will successfully obtain access to the unlicensed channel. For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

Accordingly, although a wireless network can be configured to use unlicensed spectrum to achieve faster data rates, provide a more responsive user experience, and/or offload traffic from a licensed spectrum, the need to ensure fair coexistence with incumbent systems (e.g., WLAN devices) may hamper efficient usage of the unlicensed spectrum. For example, even when there is no interference, the LBT procedure used to ensure that no other devices are already using the channel introduces a delay before transmissions can start, which may degrade user experience and/or result in unacceptable performance for latency-sensitive or delay-sensitive applications. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the COT obtained by an initiating transmitting device may have a duration that is longer than necessary for the transmitting device to perform the desired transmissions, which may lead to inefficient usage of the unlicensed channel.

Accordingly, in some cases, a wireless network may enable a COT initiated by a transmitting device to be shared with other nodes in order to improve access and/or efficiency for an unlicensed channel. For example, in downlink-to-uplink COT sharing over an access link, a network node may acquire a COT with an eCCA, and the COT may be shared with one or more UEs (e.g., UE 120, UE 305, and/or the like) that can then transmit uplink signals within the COT that was initiated by the network node. In this case, a UE attempting to initiate an uplink transmission within the COT shared with the network node can perform an uplink transmission without having to perform an LBT procedure (e.g., a Category-1 LBT procedure, also referred to as no LBT), or the UE may perform the uplink transmission after performing a one-shot CCA with a shorter LBT procedure (e.g., a Category-2 LBT procedure when the downlink-to-uplink gap duration is between 16 μs and 25 μs, and/or a Category-1 LBT procedure when a downlink-to-uplink gap duration is less than or equal to 16 μs).

Additionally, or alternatively, a wireless network may support uplink-to-downlink COT sharing from a UE to a network node over an access link. For example, a UE may perform a Category-4 LBT procedure to initiate a COT (e.g., for a configured grant PUSCH or a scheduled uplink transmission), which can be shared with the network node via group common uplink control information (GC-UCI) that indicates a starting point and duration of the remaining portion of the COT to be shared with the network node. For example, the UE may perform the Category-4 LBT procedure to initiate a COT having a 4 millisecond (ms) duration, and may only use 1 ms of the COT, such that the remaining 3 ms of the COT can be shared with another device. In this case, the network node may need to acquire the remaining portion of the COT immediately after the last transmission by the UE in the earlier (used) portion of the COT by performing Category-1 or Category-2 LBT sensing using a 16 μs gap or a 25 μs gap before the transmission by the base station. In this way, the network node may transmit control and/or broadcast signals and/or channels for any UE served by the network node, provided that the transmission contains a downlink signal, channel, and/or other transmission (e.g., a PDSCH, PDCCH, reference signal, and/or the like) intended to be received by the UE that initiated the COT.

Additionally, or alternatively, a wireless network may support UE-to-UE COT sharing over a sidelink. For example, as shown in FIG. 6, and by reference number 610, a COT initiated by a transmitting UE (e.g., UE 305-1) may be shared with a responding UE (e.g., UE 305-2) in a frequency division multiplexing (FDM) mode by dividing the COT into multiple interlaces (e.g., time periods during which one or more UEs may perform transmit operations). For example, as shown in FIG. 6, the transmitting UE that initiates the COT may use one or more sidelink resources (e.g., time and frequency resources) to transmit in a first interlace after the COT has been acquired, and a responding UE may use sidelink frequency resources that are non-overlapping with sidelink frequency resources used by the initiating UE to perform transmit operations in subsequent interlaces. Accordingly, as shown in FIG. 6, FDM or interlace-based COT sharing may introduce short transmission gaps between interlaces to allow other UEs to perform transmit operations in subsequent interlaces during a shared COT, and SCI transmitted by the COT-initiating UE may carry information to support the interlace-based COT sharing. For example, SCI that contains COT sharing information may be treated as a COT sharing grant from the initiating UE that is sharing the COT, and all responding UEs that are eligible to share the COT (e.g., based on a distance metric, a group identifier, and/or other information) may take the SCI as a COT sharing grant. In this case, a responding UE may perform a Category-1 or Category-2 LBT procedure prior to transmitting at any time up to the end of the COT, and a transmission gap limit may not apply (e.g., UEs sharing the COT can start to transmit anywhere within the shared COT region even if there is a greater than 25 μs gap between the transmission and the end of the last transmission by the COT-initiating UE).

Additionally, or alternatively, as shown by reference number 620, UE-to-UE COT sharing may be enabled in a time division multiplexing (TDM) mode. In this case, the total COT may be divided into an initial time period during which the initiating UE may perform transmissions, which may include one or more SCI transmissions that include a COT-sharing signal to indicate when the initial transmission will end, and a remaining duration of the COT that is available for sharing. Accordingly, one or more responding UEs may monitor the SCI transmitted by other UEs (e.g., the initiating UE) to recover COT sharing information that can be used to perform transmissions during a time period that corresponds to a shared COT. Accordingly, as described herein, UE-to-UE COT sharing may enable better access to unlicensed spectrum and/or more efficient usage of unlicensed spectrum by enabling multiple UEs to perform transmissions during a COT that is obtained by an initiating UE (e.g., a UE that successfully performed a Category-4 LBT procedure to acquire access to an unlicensed channel).

As indicated above, FIG. 6 is provided as an example. Other examples may differ from what is described with regard to FIG. 6.

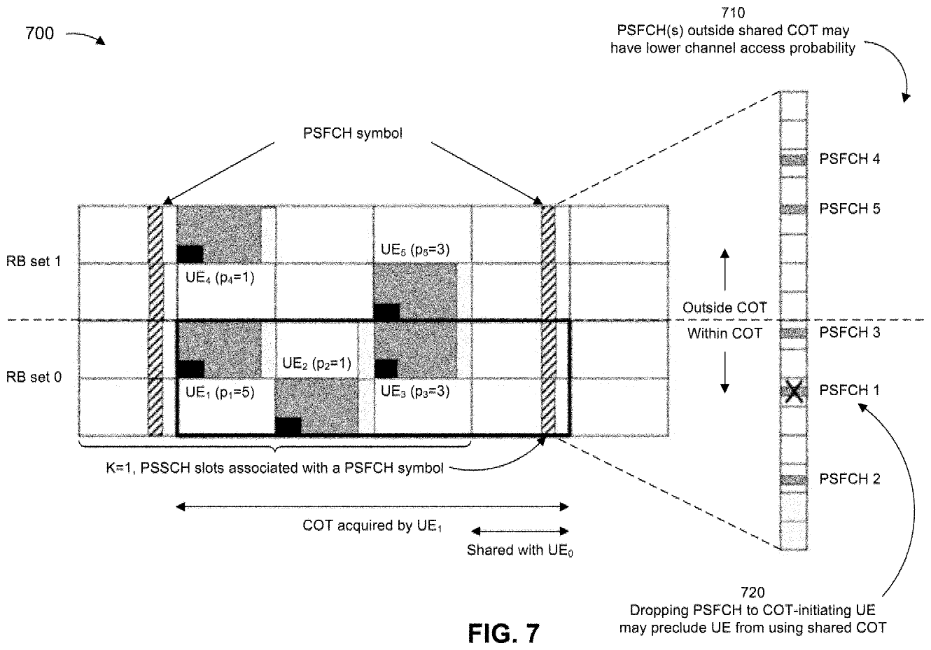

FIG. 7 is a diagram illustrating an example 700 of multiple PSFCH transmissions using a shared COT in SL-U, in accordance with the present disclosure.

In general, when a responding UE receives one or more PSSCH transmissions from one or more transmitting UEs, the responding UE may transmit one or more PSFCH transmissions that carry HARQ feedback and/or conflict information associated with the one or more PSSCH transmissions in a PSFCH transmission occasion. For example, depending on a sidelink configuration, a PSFCH symbol may be associated with one or more PSSCH slots, whereby PSFCH transmissions associated with any PSSCH transmissions that are received in the one or more PSSCH slots may be transmitted in the associated PSFCH transmission occasion. Accordingly, in cases where the responding UE receives multiple PSSCH transmissions in a time period associated with a PSFCH transmission occasion, the responding UE may have multiple simultaneous PSFCH transmissions to transmit in the associated PSFCH transmission occasion. However, the responding UE may be subject to a maximum transmit power limit for the PSFCH transmission(s) transmitted in the PSFCH transmission occasion and/or may have a capability to support only a maximum number of simultaneous PSFCH transmissions. In such cases, the responding UE may apply one or more priority rules to select the PSFCH transmission(s) to transmit in the PSFCH transmission occasion.

For example, in some cases, the responding UE may be configured with a PSFCH power control parameter (e.g., dl-P0-PSFCH) that indicates a P0 value for PSFCH power control based on a downlink pathloss. In such cases, when the responding UE is provided with the dl-P0-PSFCH parameter to configure PSFCH power control based on a downlink pathloss, the responding UE may calculate the required (e.g., minimum) PSFCH transmission power as:

$${P}_{PSFCH , one} = {P}_{O , PSFCH} + 10 {log}_{10} ( {2}^{μ} ) + {α}_{PSFCH} \cdot PL ,$$

where P_{O,PSFCH} is a value of dl-P0-PSFCH, μ is a subcarrier spacing of an active bandwidth part, α_{PSFCH} is a coefficient for path loss compensation with a value of a parameter (e.g., dl-Alpha-PSFCH) that indicates an alpha value for downlink pathloss based power control for PSFCH or a value of one (1) if the parameter that indicates an alpha value for downlink pathloss based power control for PSFCH is not configured, and PL=PL_{b,f,c}(q_{d}) when an active sidelink bandwidth part is on a serving cell c. Accordingly, when the responding UE is configured with the dl-P0-PSFCH for PSFCH power control based on downlink pathloss, the responding UE may calculate the required PSFCH transmission power using the equation provided above based on a downlink pathloss measurement associated with one or more reference signal resources. For example, in some aspects, the reference signal resource may correspond to a resource that the responding UE uses to determine a power to use for a PUSCH transmission scheduled by a DCI message having format 0_0 in serving cell c when the responding UE is configured to monitor a PDCCH to detect DCI having format 00 in serving cell c. Alternatively, when the responding UE is not configured to monitor a PDCCH to detect DCI having format 0_0 in serving cell c, the reference signal resource used to calculate the required PSFCH transmission power may correspond to a synchronization signal block (SSB) that the responding UE uses to obtain a master information block (MIB). Alternatively, in cases where the responding UE is not configured with the dl-P0-PSFCH for PSFCH power control based on downlink pathloss, the responding UE may determine how many PSFCH transmissions to transmit in a PSFCH transmission occasion and then determine the PSFCH transmission power based on the maximum transmission power PSFCH and the number of PSFCH transmissions (e.g., rather than the dl-P0-PSFCH parameter for PSFCH power control based on downlink pathloss).

In general, as described herein, the responding UE may support up to N_{max,PSFCH} simultaneous PSFCH transmissions in a PSFCH transmission occasion, whereby the responding UE may need to select N_{Tx,PSFCH} PSFCH transmissions to be transmitted in a given PSFCH transmission occasion from N_{sch,Tx,PSFCH} PSFCH transmissions that are scheduled to be transmitted in the PSFCH transmission occasion. In particular, the N_{Tx,PSFCH} PSFCH transmissions that are selected to be transmitted in the PSFCH transmission occasion may depend on whether the number of PSFCH transmissions that are scheduled to be transmitted in the PSFCH transmission occasion exceeds the maximum number of simultaneous PSFCH transmissions supported by the responding UE and/or may depend on whether the responding UE is configured with the dl-P0-PSFCH parameter for PSFCH power control based on downlink pathloss.

For example, in cases where N_{sch,Tx,PSFCH}≤N_{max,PSFCH} (e.g., the number of PSFCH transmissions scheduled in a PSFCH transmission occasion does not exceed the maximum number of simultaneous PSFCH transmissions supported by the responding UE) and dl-P0-PSFCH is configured, the number of PSFCH transmissions that are selected to be transmitted may equal the number of PSFCH transmissions scheduled in a PSFCH transmission occasion (e.g., N_{Tx,PSFCH}=N_{sch,Tx,PSFCH}) and P_{PSFCH,k}(i)=P_{PSFCH,one} in cases where the total transmission power of the scheduled PSFCH transmissions does not exceed a maximum output power (e.g., P_{PSFCH,one}+10 log₁₀(N_{sch,Tx,PSFCH})≤P_{CMAX}, where P_{CMAX} is the maximum output power).

Otherwise, in cases where N_{sch,Tx,PSFCH}≤N_{max,PSFCH} and dl-P0-PSFCH is configured, but the total transmission power of the N_{sch,Tx,PSFCH} PSFCH transmissions that are scheduled in a PSFCH transmission occasion exceeds the maximum output power, the responding UE may autonomously determine the N_{Tx,PSFCH} PSFCH transmissions to transmit in the PSFCH occasion first with an ascending order of corresponding priority values over any of the N_{sch,Tx,PSFCH} PSFCH transmissions that carry HARQ feedback information, and then with an ascending order of priority values over any of the N_{sch,Tx,PSFCH} PSFCH transmissions that carry conflict information. In other words, PSFCH transmissions that carry HARQ feedback always have a higher priority than PSFCH transmissions that carry conflict information, and priority values among the PSFCH transmissions that carry HARQ feedback and the PSFCH transmissions that carry conflict information may be determined in an ascending order based on priority values associated with the PSFCH transmissions. Accordingly, the responding UE may determine the N_{Tx,PSFCH} PSFCH transmissions to be transmitted in the PSFCH occasion such that

$${N}_{Tx , PSFCH} \geq max ( 1 , {\sum }_{i = 1}^{K} {M}_{i} ) ,$$

where Mᵢ, for 1≤i≤8, is a number of PSFCH transmissions with a priority value i for a PSFCH transmission that carries HARQ feedback and Mᵢ, for i>8, is a number of PSFCH transmissions with a priority value i−8 for PSFCH transmissions with conflict information, and K may be defined as the largest value that satisfies the following expression:

$${P}_{PSFCH , one} + 10 {log}_{10} ( max ( 1 , {\sum }_{i = 1}^{K} {M}_{i} ) ) \leq {P}_{CMAX}$$

or as zero (0) if there is no value that satisfies the foregoing expression, and

$${P}_{PSFCH , k} ( i ) = min ( {P}_{CMAX} - 10 {log}_{10} ( {N}_{Tx , PSFCH} ) , {P}_{PSFCH , one} )$$

where P_{CMAX}−10 log₁₀(N_{Tx,PSFCH}) is an allowed transmission power and P_{PSFCH,one} is a required transmission power. Accordingly, N_{Tx,PSFCH} is subject to a lower bound or minimum value, whereby the number of PSFCH transmissions that are selected for actual transmission in a PSFCH transmission occasion must equal or exceed the lower bound defined by the term

$$max ( 1 , {\sum }_{i = 1}^{K} {M}_{i} ) .$$

However, in some cases, the number of PSFCH transmissions that are scheduled in a PSFCH transmission occasion may exceed the maximum number of simultaneous PSFCH transmissions supported by the responding UE. In such cases (e.g., when N_{sch,Tx,PSFCH}>N_{max,PSFCH}), and when the dl-P0-PSFCH parameter is configured, the responding UE may first select the maximum number of simultaneous PSFCH transmissions supported by the responding UE from the PSFCH transmissions that are scheduled in the PSFCH transmission occasion in an ascending order based on priority field values associated with any of the scheduled PSFCH transmissions that carry HARQ feedback, and then in an ascending order based on priority field values associated with any of the scheduled PSFCH transmissions that carry conflict information. For example, in cases where the total transmission power of N_{max,PSFCH} PSFCH transmissions does not exceed P_{CMAX} (e.g., P_{PSFCH,one}+10 log₁₀(N_{max,PSFCH})≤P_{CMAX}), the number of PSFCH transmissions that are selected to be transmitted in the PSFCH transmission occasion may equal the maximum number of simultaneous PSFCH transmissions supported by the responding UE. Furthermore, in such cases, P_{PSFCH,k}(i)=P_{PSFCH,one} (e.g., the required transmission power determined based on the dl-P0-PSFCH parameter). Otherwise, in cases where the total transmission power of N_{max,PSFCH} PSFCH transmissions exceeds P_{CMAX}, the responding UE may autonomously select N_{Tx,PSFCH} PSFCH transmissions in an ascending order with corresponding priority field values over any PSFCH transmissions that carry HARQ feedback and then with an ascending order of priority value over any PSFCH transmissions that carry conflict information, such that

$${N}_{T x , PSPCH} \geq max ( 1 , {\sum }_{i = 1}^{K} {M}_{i} ) .$$

Accordingly, when the number of PSFCH transmissions scheduled in a PSFCH transmission occasion exceeds the maximum number of simultaneous PSFCH transmissions supported by the responding UE, the responding UE may first select, from the PSFCH transmissions scheduled in the PSFCH transmission occasion, the maximum number of simultaneous PSFCH transmissions supported by the responding UE and then select the PSFCH transmissions to transmit in the PSFCH transmission occasion using the same priority rules that apply when the number of PSFCH transmissions scheduled in a PSFCH transmission occasion does not exceed the maximum number of simultaneous PSFCH transmissions supported by the responding UE.

Alternatively, in cases where PSFCH power control based on downlink pathloss is not configured (e.g., the dl-P0-PSFCH parameter is not configured), the responding UE may autonomously determine N_{Tx,PSFCH} PSFCH transmissions to transmit in a PSFCH transmission occasion in an ascending order with corresponding priority field values over any PSFCH transmissions that carry HARQ feedback and then in an ascending order of priority value over any PSFCH transmissions that carry conflict information such that N_{Tx,PSFCH}≥1, where P_{CMAX} may be determined for the N_{Tx,PSFCH} PSFCH transmissions selected for transmission in the PSFCH transmission occasion.

In general, the priority rules that are described above for handling multiple simultaneous PSFCH transmissions are defined for sidelink operation in a licensed band, and therefore do not consider certain factors that may impact sidelink operation in unlicensed bands. For example, in SL-U, a UE that needs to transmit a sidelink message (e.g., a PSCCH message, a PSSCH message, and/or a PSFCH message) may be required to perform a Cat-4 LBT procedure prior to transmitting, in cases where COT sharing is not available. However, in cases where COT sharing is available, the UE that needs to transmit may perform a Cat-2 LBT procedure, which may enable the UE to access the unlicensed channel more easily. For example, when UE-to-UE COT sharing is enabled (e.g., as described above with reference to FIG. 6), a responding UE that is attempting to transmit one or more PSFCH transmissions over an unlicensed channel can utilize a COT shared by a transmitting UE that initiated the COT when at least one of the PSFCH transmissions that the responding UE is transmitting in a symbol or slot within a resource block (RB) set that corresponds to the shared COT is intended for or directed to the transmitting UE that initiated the COT. Furthermore, in some cases, the responding UE may be permitted to use the shared COT to transmit one or more PSFCH transmissions to other UEs (e.g., other than the transmitting UE that initiated the COT).

However, as described herein, a responding UE may be subject to a limitation on the maximum number of PSFCH transmissions that can be simultaneously transmitted in a given PSFCH occasion due to a capability of the responding UE (e.g., a maximum number of simultaneous PSFCH transmissions supported by the UE, N_{max,PSFCH}) and/or a maximum transmission power constraint (e.g., the applicable value for P_{CMAX}). For example, when the number of simultaneous PSFCH transmissions that are scheduled in a PSFCH transmission occasion exceeds the capability of the responding UE and/or the total transmission power of the PSFCH transmissions to be simultaneously transmitted exceeds the maximum transmission power, the responding UE may apply priority rules to select the PSFCH transmissions to be transmitted based on information carried by the PSFCH transmissions (e.g., with HARQ feedback having a higher priority than conflict indication), and based on an ascending order of the priority values for the information carried by each PSFCH transmission. However, in an unlicensed band, an in-COT PSFCH transmission (e.g., a PSFCH transmission within a shared COT) and an out-COT PSFCH transmission (e.g., a PSFCH transmission outside a shared COT) may use different channel access types and may therefore have different channel access probabilities. Furthermore, among in-COT PSFCH transmissions, whether a PSFCH transmission is intended for a UE that initiated the shared COT may impact whether the responding UE can use the shared COT to perform in-COT PSFCH transmissions toward one or more UEs other than the UE that initiated the shared COT. For example, in cases where one or more PSFCH transmissions intended for the UE that initiated the shared COT are dropped (e.g., due to the number of simultaneous PSFCH transmissions scheduled in a PSFCH transmission occasion exceeding the capability of the responding UE and/or the total transmission power of the PSFCH transmissions to be simultaneously transmitted exceeding the maximum transmission power), the responding UE may be unable to use the shared COT to transmit PSFCH transmissions toward any UEs other than the UE that initiated the COT, which may increase an LBT failure probability for the in-COT PSFCH transmissions directed to any UEs other than the UE that initiated the COT.

For example, referring to FIG. 7, example 700 depicts a scenario in which a responding UE (UE₀) receives multiple PSSCH transmissions associated with a PSFCH transmission occasion over an unlicensed sidelink channel. Accordingly, the responding UE may have multiple PSFCH transmissions to be transmitted in the PSFCH transmission occasion, shown as a PSFCH symbol. For example, as shown in FIG. 7, the responding UE may receive a first PSSCH transmission from a first UE (UE₁), a second PSSCH transmission from a second UE (UE₂), a third PSSCH transmission from a third UE (UE₃), a fourth PSSCH transmission from a fourth UE (UE₄), and a fifth PSSCH transmission from a fifth UE (UE₅), where each PSFCH to be transmitted in the PSFCH transmission occasion may correspond to the time and frequency locations of an associated PSSCH transmission. For example, in FIG. 7, a PSFCH k may refer to a PSFCH transmission directed to UEₖ (e.g., PSFCH 1 is directed to UE₁, PSFCH 2 is directed to UE₂, and so on). Furthermore, in example 700, the first transmitting UE (UE₁) may be a UE that initiated a COT, which may be shared with the responding UE so that the responding UE can use a portion of the shared COT for PSFCH transmission (e.g., the last slot of the shared COT, which includes the PSFCH transmission occasion). Accordingly, as shown in FIG. 7, PSFCH transmissions 1 through 3 are in-COT PSFCH transmissions (e.g., because the PSFCH transmissions 1 through 3 are within RB set 0 associated with the shared COT), and PSFCH transmissions 4 and 5 are out-COT PSFCH transmissions (e.g., because PSFCH transmissions 4 and 5 are within RB set 1, which is outside the RB set associated with the shared COT). As a result, as shown by reference number 710, the responding UE may be unable to use COT sharing to transmit the out-COT PSFCH transmissions (e.g., the responding UE may need to perform a Cat-4 LBT procedure to transmit the out-COT PSFCH transmissions), whereby the out-COT PSFCH transmissions may have a lower channel access probability than the in-COT PSFCH transmissions.

Furthermore, in cases where the responding UE cannot transmit all five PSFCH transmissions that are scheduled in the PSFCH transmission occasion (e.g., due to a maximum transmission power limit and/or the UE capability limit), the responding UE may need to select one or more PSFCH transmissions to be transmitted. For example, in cases where the responding UE applies the legacy priority rules described above and the PSFCH transmissions scheduled in the PSFCH transmission occasion all carry the same type of information (e.g., either HARQ feedback or conflict information), the PSFCH transmissions may be ranked in ascending order based on priority field values. For example, as shown, the PSFCH transmission associated with the PSSCH from UE₁ has a priority of 5 (p₁=5), the PSFCH transmission associated with the PSSCH from UE₂ has a priority of 1 (p₂=1), the PSFCH transmission associated with the PSSCH from UE₃ has a priority of 3 (p₃=3), the PSFCH transmission associated with the PSSCH from UE₄ has a priority of 1 (p₄=1), and the PSFCH transmission associated with the PSSCH from UE₅ has a priority of 3 (p₅=³). Based on the priority rules ranking PSFCH transmissions in ascending order of priority values (e.g., where a larger priority value corresponds to a lower priority), the PSFCH transmissions directed to UE₄ and UE₂ have a highest priority, the PSFCH transmissions directed to UE₃ and UE₅ have a next highest priority, and the PSFCH transmission directed to UE₁ has a lowest priority.

Accordingly, as shown by reference number 720, applying the legacy priority rules to handle the simultaneous PSFCH transmissions (e.g., when the PSFCH transmissions scheduled in a PSFCH transmission occasion exceed the UE capability and/or maximum transmission power limit) may result in the responding UE dropping the PSFCH transmission to UE₁, which has the lowest probability. As a result, the responding UE may be unable to use the COT shared by UE₁ for the other in-COT PSFCH transmissions to UE₂ and UE₃ because there is no PSFCH transmission intended for the UE that initiated the shared COT (e.g., UE₁). In such a case, the channel access probability for the PSFCH transmissions to UE₂ and UE₃ would be lower, because the responding UE would need to perform a Cat-4 LBT procedure rather than a Cat-2 LBT procedure. However, if the responding UE were to transmit the PSFCH transmission directed to UE₁, the responding UE would be able to use the shared COT to transmit all of the in-COT PSFCH transmissions to UE₁, UE₂, and UE₃ (subject to the UE capability and/or maximum transmission power limit). Accordingly, some aspects described herein relate to techniques associated with priority handling for simultaneous PSFCH transmissions in an unlicensed channel, where the priority handling may include one or more rules that are based on whether the PSFCH transmissions scheduled in a PSFCH transmission are within or outside a shared COT.

As indicated above, FIG. 7 is provided as an example. Other examples may differ from what is described with regard to FIG. 7.

FIG. 8 is a diagram illustrating an example 800 associated with selecting a number of PSFCH transmissions to transmit in a PSFCH transmission occasion when using a shared COT in SL-U, in accordance with the present disclosure.

In some aspects, as described herein, example 800 relates to a scenario in which a responding UE receives multiple PSSCH transmissions associated with a PSFCH transmission occasion over an unlicensed channel, and at least one PSFCH transmission that is scheduled in the PSFCH transmission occasion is in a shared COT.

Accordingly, in such cases, the responding UE may determine a minimum number of PSFCH transmissions to be transmitted in the PSFCH occasion based on whether the PSFCH transmissions scheduled to be transmitted in the PSFCH occasion are in-COT PSFCH transmissions or out-COT PSFCH transmissions. For example, in cases where the responding UE supports up to N_{max,PSFCH} simultaneous PSFCH transmissions in a PSFCH transmission occasion and the responding UE has N_{sch,Tx,PSFCH} PSFCH transmissions to be transmitted in a given PSFCH transmission occasion, the UE may determine a value of N_{Tx,PSFCH} (e.g., corresponding to a minimum number of PSFCH transmissions to be transmitted in the PSFCH transmission occasion) based on whether the PSFCH transmissions are in-COT or out-COT PSFCH transmissions, if at least one of the PSFCH transmissions in a symbol or slot within an RB set corresponding to a shared COT is intended for a UE that initiated the shared COT.

For example, in cases where the number of PSFCH transmissions scheduled in the PSFCH transmission occasion is less than or equal to (e.g., does not exceed) the maximum number of simultaneous PSFCH transmissions supported by the responding UE and a dl-P0-PSFCH parameter configuring PSFCH power control based on downlink pathloss is configured, the responding UE may determine the appropriate value of N_{Tx,PSFCH} if the PSFCH transmissions scheduled in the PSFCH transmission occasion have a total transmission power that exceeds P_{CMAX}. In such cases, the responding UE may determine the value of N_{Tx,PSFCH} such that N_{Tx,PSFCH}≥X≥1 (e.g., X is a lower bound on the value of N_{Tx,PSFCH}, and X must be greater than or equal to one). Furthermore, in some aspects, X may be defined as:

$$X = max ( {\sum }_{i = 1}^{K} {M}_{i} , Y ) ,$$

where K is the largest value that ensures that the total transmission power of all

$${\sum }_{i = 1}^{K} {M}_{i}$$

PSFCH transmissions does not exceed P_{CMAX} and Y is a PSFCH index of a specific PSFCH that satisfies a condition that allows the responding UE to utilize the shared COT. For example, in some aspects, each PSFCH transmission that is scheduled to be transmitted in the PSFCH transmission occasion may be assigned an index in ascending order based on the priority rules described above with reference to FIG. 6 (e.g., with any PSFCH transmissions carrying HARQ feedback having a higher priority than any PSFCH transmissions carrying conflict information, and PSFCH transmissions carrying the same information type being prioritized in ascending order based on priority field values). Furthermore, for any PSFCH transmissions with the same priority, the PSFCH transmissions may be indexed based on the time domain and/or frequency domain location of the associated PSSCH. In some aspects, the specific PSFCH that satisfies the condition that allows the responding UE to utilize the shared COT may correspond to the first PSFCH transmission that is in the shared COT, the first PSFCH transmission that is in the shared COT and intended for the UE that initiated the shared COT, the last PSFCH transmission that ensures that at least one in-COT PSFCH is transmitted in the shared COT or the RB set corresponding to the shared COT, or the last PSFCH transmission that ensures that at least one in-COT PSFCH that is intended for the UE that initiated the shared COT is transmitted in the shared COT or RB set.

Alternatively, in cases where the number of PSFCH transmissions scheduled in the PSFCH transmission occasion exceeds the maximum number of simultaneous PSFCH transmissions supported by the responding UE and the dl-P0-PSFCH parameter is configured, the responding UE may first select N_{max,PSFCH} PSFCH transmissions to be transmitted in the PSFCH transmission occasion based on the priority rules described in further detail above, where N_{max,PSFCH} is the maximum number of simultaneous PSFCH transmissions supported by the responding UE. The responding UE may then select N_{Tx,PSFCH} PSFCH transmissions from the N_{max,PSFCH} PSFCH transmissions, where

$${N}_{Tx , PSFCH} \geq X \geq 1 , X = max ( {\sum }_{i = 1}^{K} {M}_{i} , Y ) ,$$

K is the largest value that ensures that the total transmission power of all

$${\sum }_{i = 1}^{K} {M}_{i}$$

PSFCH transmissions does not exceed P_{CMAX}, and Y is either the PSFCH index of a specific PSFCH that satisfies a condition that allows the responding UE to utilize the shared COT if the PSFCH index does not exceed N_{max,PSFCH} or is equal to

$${\sum }_{i = 1}^{K} {M}_{i}$$

if the PSFCH index exceeds N_{max,PSFCH}.

Alternatively, in cases where the dl-P0-PSFCH parameter is not configured (e.g., the responding UE is unable to determine the required PSFCH transmission power based on downlink pathloss), the responding UE may select N_{Tx,PSFCH} PSFCH transmissions to transmit in a PSFCH transmission occasion based on existing priority rules, where N_{Tx,PSFCH}≥Y≥1, and Y is the PSFCH index of a specific PSFCH that allows the responding UE to utilize the shared COT (e.g., corresponding to the first PSFCH transmission that is in the shared COT, the first PSFCH transmission that is in the shared COT and intended for the UE that initiated the shared COT, the last PSFCH transmission that ensures that at least one in-COT PSFCH is transmitted in the shared COT or the RB set corresponding to the shared COT, or the last PSFCH transmission that ensures that at least one in-COT PSFCH that is intended for the UE that initiated the shared COT is transmitted in the shared COT or RB set).

For example, as shown in FIG. 8, a responding UE (e.g., UE₀) may receive multiple PSSCH transmissions that are associated with a PSFCH transmission occasion, which includes at least one PSFCH transmission directed to a transmitting UE that initiated a COT being shared with the responding UE. As shown by reference number 810, the UE may select the minimum number of PSFCH transmissions to transmit in the PSFCH transmission occasion based on whether the PSFCH transmissions are within the shared COT or outside the shared COT. As described herein, example 800 relates to a scenario where the number of PSFCH transmissions scheduled in the PSFCH transmission occasion does not exceed the maximum number of simultaneous PSFCH transmissions supported by the responding UE. However, similar techniques may be applied in cases where the number of PSFCH transmissions scheduled in the PSFCH transmission occasion exceeds the maximum number of simultaneous PSFCH transmissions supported by the responding UE (e.g., the responding UE may first select the maximum supported number of simultaneous PSFCH transmissions from the scheduled PSFCH transmissions using legacy priority rules, and may then apply the same techniques as applied when the number of scheduled PSFCH transmissions does not exceed the maximum simultaneous PSFCH transmissions supported by the responding UE).

For example, as shown by reference number 820, each PSFCH transmission that is scheduled to be transmitted in the PSFCH transmission occasion may be indexed according to a priority value and/or a time/frequency location of the associated PSSCH. For example, PSFCH transmissions to UE₂ and UE₅ are associated with highest priority values (p₂=1 and p₅=1), and the associated PSSCH transmission from UE₂ is earlier than the associated PSSCH transmission from UE₅ in the time domain and lower in the frequency domain. Accordingly, the PSFCH transmission to UE₂ is assigned an index of 1, and the PSFCH transmission to UE₅ is assigned an index of 2. Furthermore, the same pattern may be applied to the remaining PSFCH transmissions to UE₁, UE₃, and UE₄. In this example, based on legacy priority rules, PSFCH1=PSFCH2>PSFCH3>PSFCH 4>PSFCH 5. In one example, assuming that P_{PSFCH1}+P_{PSFCH2}+P_{PSFCH3}+P_{PSFCH4}≤P_{CMAX}, but P_{PSFCH1}+P_{PSFCH2}+P_{PSFCH3}+P_{PSFCH4}+P_{PSFCH5}>P_{CMAX}, K may have a value of 3, which is the largest value that ensures that the total transmission power of all

$${\sum }_{i = 1}^{3} {M}_{i}$$

PSFCH transmissions does not exceed P_{CMAX}. Accordingly, based on the rules specifying that

$${N}_{T x , PSFCH} \geq X and X = max ( {\sum }_{i = 1}^{K} {M}_{i} , Y ) ,$$

X may have a value corresponding to max(M₁+M₂+M₃, Y), where M₁ has a value of 2 (e.g., based on there being two PSFCH transmissions with a priority of 1), M₂ has a value of 1 (e.g., based on there being one PSFCH transmission with a priority of 2), and M₃ has a value of 1 (e.g., based on there being one PSFCH transmission with a priority of 3).

Accordingly, in example 800 depicted in FIG. 8, X may have a value corresponding to max(M₁+M₂+M₃, Y)=max(4, Y), where Y is the PSFCH index of a specific PSFCH that allows the responding UE to utilize the shared COT. For example, in cases where the specific PSFCH that allows the responding UE to utilize the shared COT is the first PSFCH transmission that is in the shared COT, Y has a value of 1 (e.g., corresponding to PSFCH 1 directed to UE₂), whereby N_{Tx,PSFCH}≥4. Alternatively, in cases where the specific PSFCH that allows the responding UE to utilize the shared COT is the first PSFCH transmission that is in the shared COT and intended for the UE that initiated the shared COT (e.g., UE₁), Y has a value of 5 (e.g., corresponding to PSFCH 5 directed to UE₁), whereby N_{Tx,PSFCH}≥5. Alternatively, in cases where the specific PSFCH that allows the responding UE to utilize the shared COT is the last PSFCH transmission that ensures that at least one in-COT PSFCH is transmitted in the shared COT or the RB set corresponding to the shared COT, Y has a value of 1 (e.g., corresponding to PSFCH 1 directed to UE₂), whereby N_{Tx,PSFCH}≥4. Alternatively, in cases where the specific PSFCH that allows the responding UE to utilize the shared COT is the last PSFCH transmission that ensures that at least one in-COT PSFCH that is intended for the UE that initiated the shared COT is transmitted in the shared COT or RB set, Y has a value of 5 (e.g., corresponding to PSFCH 5 directed to UE₁), whereby N_{Tx,PSFCH}≥5. In this way, the responding UE may select the minimum number (or lower bound) of PSFCH transmissions for the PSFCH transmission occasion in a manner that ensures that the responding UE will be able to utilize the shared COT.

As indicated above, FIG. 8 is provided as an example. Other examples may differ from what is described with regard to FIG. 8.

FIGS. 9A-9B are diagrams illustrating examples 900 associated with selecting PSFCH transmissions to transmit in a PSFCH transmission occasion when using a shared COT in SL-U, in accordance with the present disclosure.

In some aspects, as described herein, examples 900 relate to scenarios in which a responding UE receives multiple PSSCH transmissions associated with a PSFCH transmission occasion over an unlicensed channel, and at least one PSFCH transmission that is scheduled in the PSFCH transmission occasion is in a shared COT. For example, as described herein, the PSFCH transmissions that are scheduled in a PSFCH transmission occasion may generally carry HARQ feedback or conflict information for an associated PSSCH. Accordingly, in such cases, the responding UE may select N_{Tx,PSFCH} PSFCH transmissions to transmit in a PSFCH occasion from N_{sch,Tx,PSFCH} PSFCH transmissions that are scheduled to be transmitted in the PSFCH occasion when the scheduled PSFCH transmissions have a total transmission power that exceeds a maximum transmission power limit and/or the number of scheduled PSFCH transmissions exceeds a maximum number of simultaneous PSFCH transmissions supported by the responding UE.

For example, in cases where the number of PSFCH transmissions scheduled in the PSFCH transmission occasion does not exceed the maximum number of simultaneous PSFCH transmissions supported by the responding UE (e.g., N_{sch,Tx,PSFCH}; N_{max,PSFCH}) and a dl-P0-PSFCH parameter configuring PSFCH power control based on downlink pathloss is configured, the responding UE may select N_{Tx,PSFCH} PSFCH transmissions for actual transmission in the corresponding PSFCH transmission occasion if the scheduled PSFCH transmissions have a total transmission power that exceeds P_{CMAX}. In such cases, the responding UE may initially select N_{Tx,PSFCH} PSFCH transmissions over one or more in-COT PSFCH transmissions, and may then select one or more PSFCH transmissions from a set of out-COT PSFCH transmissions such that N_{Tx,PSFCH}≥X≥1, where

$$X = max ( 1 , {\sum }_{\dot{t} = 1}^{K} {M}_{i} )$$

and K is the largest value that ensures that the total transmission power of all

$${\sum }_{i = 1}^{K} {M}_{i}$$

PSFCH transmissions does not exceed P_{CMAX}, Mᵢ is the number of PSFCHs with i-th priority.

For example, in some aspects, among the in-COT PSFCH transmissions, the responding UE may generally select the PSFCH transmissions to be transmitted in the PSFCH transmission occasion based on the priority values associated with the PSFCH transmissions to be transmitted in the PSFCH transmission occasion, the information carried in the PSFCH transmissions to be transmitted in the PSFCH transmission occasion, and/or the type of UE intended to receive the PSFCH transmissions to be transmitted in the PSFCH transmission occasion. For example, in some aspects, the responding UE may use the information carried in the PSFCH transmissions as a primary criterion for selecting the PSFCH transmissions to be transmitted in the PSFCH transmission occasion, and may use the priority values associated with the PSFCH transmissions as a secondary criterion (e.g., the responding UE may first select one or more PSFCH transmissions in an ascending order of corresponding priority field values over any PSFCH transmissions that carry HARQ feedback for an associated PSSCH transmission, and may then select one or more PSFCH transmissions in an ascending order of corresponding priority field values over any remaining PSFCH transmissions that carry conflict information).

Alternatively, in some aspects, among the in-COT PSFCH transmissions, the responding UE may use the type of the UE intended to receive the PSFCH transmissions as a primary criterion for selecting the PSFCH transmissions to be transmitted in the PSFCH transmission occasion, and may use the priority values associated with the PSFCH transmissions as a secondary criterion. For example, in some aspects, the responding UE may first select one or more PSFCH transmissions in an ascending order of corresponding priority field values over any PSFCH transmissions that are directed to a transmitting UE that initiated a shared COT, and may then select one or more PSFCH transmissions in an ascending order of corresponding priority field values over any remaining PSFCH transmissions that are directed to transmitting UEs other than a COT-initiating UE. Alternatively, in some aspects, the responding UE may first select a PSFCH transmission associated with a lowest priority field value (e.g., a highest priority) or a PSFCH transmission associated with an earliest slot (e.g., in cases where there are multiple PSFCH transmissions that are intended for the COT-initiating UEs and have the same priority) for each RB set over the PSFCH transmissions intended for the COT-initiating UE(s), and the responding UE may then select one or more PSFCH transmissions in an ascending order of priority values over the remaining PSFCH transmissions.

Alternatively, in some aspects, the responding UE may use the type of the UE intended to receive the PSFCH transmissions as a primary criterion for selecting the PSFCH transmissions to be transmitted in the PSFCH transmission occasion, may use the information carried in the PSFCH transmissions as a secondary criterion, and may use the priority values associated with the PSFCH transmissions as a tertiary criterion. For example, in some aspects, the responding UE may first select one or more PSFCH transmissions in an ascending order of corresponding priority field values over any PSFCH transmissions that carry HARQ feedback for an associated PSSCH and are intended for a COT-initiating UE(s), may then select in an ascending order of corresponding priority field values over any PSFCH transmissions that carry conflict information and are intended for COT-initiating UE(s), may then select in an ascending order of priority values over any PSFCH transmissions that carry HARQ feedback and are intended for UEs other than the COT-initiating UE(s), and may then select in an ascending order of priority values over any PSFCH transmissions that carry conflict information and are intended for UEs other than the COT-initiating UE(s). Alternatively, in some aspects, the responding UE may first select a PSFCH transmission associated with a lowest priority field value (e.g., a highest priority) or a PSFCH transmission associated with an earliest slot (e.g., in cases where there are multiple PSFCH transmissions intended for the COT-initiating UEs that have the same priority) for each RB set over any PSFCH transmissions intended for the COT-initiating UE(s), may then select the PSFCH transmissions over the remaining PSFCH transmissions in an ascending order of corresponding priority field values over the PSFCH transmissions that carry HARQ feedback, and may then select in an ascending order of priority field values over any PSFCH transmissions that carry conflict information.

In some aspects, after selecting the in-COT PSFCH transmissions using the techniques described above, the responding UE may select one or more out-COT PSFCH transmissions to be included among the PSFCH transmissions in the PSFCH transmission occasion in cases where the number of selected in-COT PSFCH transmissions does not exceed N_{Tx,PSFCH}. For example, among a set of out-COT PSFCH transmissions, the responding UE may select one or more PSFCH transmissions to be transmitted in the PSFCH transmission occasion based on the priority values of the out-COT PSFCH transmissions and/or the information carried in the out-COT PSFCH transmissions. For example, in some aspects, the responding UE may first select one or more out-COT PSFCH transmissions in an ascending order of priority field values over any of the out-COT PSFCH transmissions that carry HARQ feedback, and may then select one or more out-COT PSFCH transmissions in an ascending order of priority field values over any of the out-COT PSFCH transmissions that carry conflict information. Alternatively, in cases where the responding UE is communicating according to an SL-U configuration that does not support a conflict indication, the out-COT PSFCH transmissions may be selected based only on the priority values of the out-COT PSFCH transmissions.

For example, as shown in FIG. 9A, and by reference number 910, the responding UE may select one or more PSFCH transmissions to be transmitted in a PSFCH transmission occasion using the criteria described above, which are generally based on whether the PSFCH transmissions are within or outside a shared COT. For example, FIG. 9A depicts a scenario where a responding UE receives multiple PSSCH transmissions that are associated with a PSFCH transmission occasion, including one or more PSFCH transmissions that are directed to a UE that initiated a shared COT (e.g., UE₁ in the illustrated example). In the example illustrated in FIG. 9A, each PSFCH transmission that is scheduled to be transmitted in the PSFCH transmission occasion may carry the same information type (e.g., HARQ feedback or conflict information). Accordingly, in cases where the responding UE selects one or more in-COT PSFCH transmissions using information carried in the PSFCH transmissions as a primary criterion and using a priority value as a secondary criterion, the various PSFCH transmissions may be prioritized as PSFCH 2>PSFCH 3>PSFCH 1-1=PSFCH 1-2>PSFCH 4>PSFCH 5, where PSFCH k may refer to a PSFCH to be transmitted to UEₖ and PSFCH k−i may refer to the ith PSFCH to be transmitted to UEₖ in cases where there are multiple PSFCH transmissions directed to UEₖ.

Alternatively, in cases where the responding UE first selects in-COT PSFCH transmissions in an ascending order of corresponding priority field values over any PSFCH transmissions intended for a COT-initiating UE, and then in an ascending order of priority value over any PSFCH transmissions intended for UEs other than the COT-initiating UE(s), the various PSFCH transmissions may be prioritized as PSFCH 1-1=PSFCH1-2>PSFCH2>PSFCH3>PSFCH4>PSFCH5. Alternatively, in cases where the responding UE first selects a PSFCH transmission associated with a lowest priority field value or a PSFCH transmission associated with an earliest slot for each RB set over any PSFCH transmissions intended for a COT-initiating UE, and then selects PSFCH transmissions in an ascending order of priority values over the remaining PSFCH transmissions, the various PSFCH transmissions may be prioritized as PSFCH1-1>PSFCH2>PSFCH3>PSFCH1-2>PSFCH4>PSFCH5. Furthermore, in a scenario where P_{PSFCH2}+P_{PSFCH3}+P_{PSFCH1-1}+P_{PSFCH1-2}+P_{PSFCH4}≤P_{CMAX} and P_{PSFCH2}+P_{PSFCH3}+P_{PSFCH1-1}+P_{PSFCH1-2}+P_{PSFCH4}+P_{PSFCH5}>P_{CMAX}, X may have a value of 4, based on the definition whereby

$$X = max ( 1 , {\sum }_{i = 1}^{K} {M}_{i} )$$

and K is the largest value to ensure that the total transmission power of all

$${\sum }_{i = 1}^{K} {M}_{i}$$

PSFCH transmissions does not exceed P_{CMAX}, Mᵢ is the number of PSFCHs with i-th priority.

Additionally, or alternatively, in cases where the total transmission power of the PSFCH transmissions that are scheduled to be transmitted in a PSFCH transmission occasion exceeds P_{CMAX}, the responding UE may select N_{Tx,PSFCH} PSFCH transmissions to be transmitted in the PSFCH transmission occasion based on one or more rules, where

$${N}_{T x , PSFCH} \geq X \geq 1 , X = max ( 1 , {\sum }_{i = 1}^{K} {M}_{i} )$$

and K is the largest value that ensures that the total transmission power of all

$${\sum }_{i = 1}^{K} {M}_{i}$$

PSFCH transmissions does not exceed P_{CMAX}, Mᵢ is the number of PSFCHs with i-th priority. For example, if the total transmission power of the PSFCH transmissions that are scheduled for the PSFCH transmission occasion exceeds P_{CMAX}, the responding UE may first select a PSFCH transmission associated with a lowest priority field value or a PSFCH transmission associated with an earliest slot (e.g., in cases where there are multiple PSFCH transmissions intended for a COT-initiating UE that have the same priority) for each RB set over the in-COT PSFCH transmissions, and may then select the PSFCH transmissions over the remaining PSFCH transmissions (e.g., based on the legacy priority rules described elsewhere herein) in an ascending order of corresponding priority field values over any PSFCH transmissions that carry HARQ feedback and then in an ascending order of priority value over any PSFCH transmissions that carry conflict information. For example, when this rule is applied to select the PSFCH transmissions to be transmitted in the PSFCH transmission occasion in the scenario depicted in FIG. 9A, the various PSFCH transmissions may be prioritized such that PSFCH 2=PSFCH 4>PSFCH 3=PSFCH 5>PSFCH 1-1=PSFCH 1-2.

Alternatively, if the total transmission power of the PSFCH transmissions that are scheduled for the PSFCH transmission occasion exceeds P_{CMAX}, the responding UE may first select a PSFCH transmission associated with a lowest priority field value or a PSFCH transmission associated with an earliest slot (e.g., in cases where there are multiple PSFCH transmissions intended for the COT-initiating UE(s) that have the same priority) for each RB set over the in-COT PSFCH transmissions that are intended for a COT initiating UE, and the responding UE may then select the PSFCH transmissions over the remaining PSFCH transmissions (e.g., based on the legacy priority rules described herein) in an ascending order of corresponding priority field values over any PSFCH transmissions that carry HARQ feedback and then in an ascending order of priority value over any PSFCH transmissions that carry conflict information. For example, when this rule is applied to select the PSFCH transmissions to be transmitted in the PSFCH transmission occasion in the scenario depicted in FIG. 9A, the various PSFCH transmissions may be prioritized such that PSFCH 1-1>PSFCH 2 PSFCH4>PSFCH 3=PSFCH 5>PSFCH 1-2.

Furthermore, although the techniques used to select the PSFCH transmissions that are transmitted in a PSFCH occasion are described herein with respect to a scenario where the number of PSFCH transmissions scheduled in a PSFCH transmission occasion do not exceed the maximum number of simultaneous PSFCH transmissions supported by the responding UE, similar techniques may be used when the number of PSFCH transmissions scheduled in a PSFCH transmission occasion exceeds the maximum number of simultaneous PSFCH transmissions supported by the responding UE. For example, in such cases (e.g., when N_{sch,Tx,PSFCH}>N_{max,PSFCH} and dl-P0-PSFCH is configured) the responding UE may first select N_{max,PSFCH} PSFCHs from the N_{sch,Tx,PSFCH} PSFCH transmissions that are scheduled in the PSFCH transmission occasion (e.g., using the techniques described above). For example, if the total transmission power of the N_{max,PSFCH} PSFCH transmissions exceeds P_{CMAX}, the responding UE may select N_{Tx,PSFCH} PSFCH transmissions from N_{max,PSFCH} PSFCH transmissions, where

$${N}_{Tx , PSFCH} \geq X \geq 1 , X = max ( 1 , {\sum }_{i = 1}^{K} {M}_{i} ) ,$$

and K is the largest value that ensures that the total transmission power of all

$${\sum }_{i = 1}^{K} {M}_{i}$$

PSFCHs does not exceed P_{CMAX}, Mᵢ is the number of PSFCHs with i-th priority.

For example, as shown in FIG. 9B, and by reference number 920, the responding UE may initially select one or more PSFCH transmissions to be dropped when the number of PSFCH transmissions to be transmitted in a PSFCH transmission occasion exceeds the capability of the responding UE. For example, in some aspects, the responding UE may first select one or more PSFCH transmissions over the in-COT PSFCH transmissions, and may then select one or more PSFCH transmissions over the out-COT PSFCH transmissions. In the illustrated example, N_{max,PSFCH}=4, and there are 5 PSFCH transmissions scheduled to be transmitted in the PSFCH transmission occasion. Accordingly, the responding UE may need to select 4 PSFCH transmissions to be transmitted in the PSFCH transmission occasion out of the 5 PSFCH transmissions scheduled to be transmitted. For example, in cases where the in-COT transmissions are selected based on carried information first and priority value second, the various PSFCH transmissions may be prioritized such that PSFCH 2>PSFCH 3>PSFCH 1>PSFCH 5>PSFCH 4 (e.g., in-COT PSFCH transmissions 1-3 have higher priorities than out-COT PSFCH transmissions 4-5, PSFCH 2 has a lowest priority field value corresponding to a highest priority among in-COT PSFCH transmissions, and PSFCH 4 has a highest priority field value corresponding to a lowest priority among out-COT PSFCH transmissions). Accordingly, in this example, the responding UE may drop PSFCH 4.

Alternatively, in cases where the in-COT transmissions are selected based on intended UE type first and priority value second, the various PSFCH transmissions may be prioritized such that PSFCH 1>PSFCH 2>PSFCH 3>PSFCH 5>PSFCH 4 (e.g., in-COT PSFCH transmissions 1-3 have higher priorities than out-COT PSFCH transmissions 4-5, PSFCH 1 has a highest priority based on being directed to a COT-initiating UE, in-COT PSFCH 2 has a lower priority field value (corresponding to a higher priority) than in-COT PSFCH 3, and out-COT PSFCH 4 has a highest priority field value corresponding to a lowest priority among the out-COT PSFCH transmissions). Accordingly, in this example, the responding UE may similarly drop PSFCH 4 with the lowest priority. As further shown in FIG. 9B, and by reference number 930, the responding UE may then select the PSFCH transmissions to transmit in the PSFCH transmission occasion from the remaining PSFCH transmissions, subject to any transmission power constraints. For example, the responding UE may select N_{Tx,PSFCH} PSFCH transmissions from the four PSFCH transmissions selected in the first step, where N_{Tx,PSFCH}≥3 if P_{PSFCH1}+P_{PSFCH2}+P_{PSFCH3}≤P_{CMAX} and P_{PSFCH1}+P_{PSFCH2}+P_{PSFCH3}+P_{PSFCH5}>P_{CMAX}.

Furthermore, in some aspects, the same or similar techniques may be applied in cases where the dl-P0-PSFCH parameter is not configured. For example, in such cases, the responding UE may select N_{Tx,PSFCH} PSFCH transmissions to transmit in the PSFCH transmission occasion using the techniques described herein, where N_{Tx,PSFCH}≥1.

As indicated above, FIGS. 9A-9B are provided as examples. Other examples may differ from what is described with regard to FIGS. 9A-9B.

FIG. 10 is a diagram illustrating an example process 1000 performed, for example, by a UE, in accordance with the present disclosure. Example process 1000 is an example where the UE (e.g., UE 120) performs operations associated with techniques for priority handling for simultaneous PSFCHs in SL-U.

As shown in FIG. 10, in some aspects, process 1000 may include receiving, over an unlicensed sidelink channel, multiple PSSCH transmissions associated with a PSFCH transmission occasion, wherein at least one PSFCH transmission in the PSFCH transmission occasion is in a shared COT (block 1010). For example, the UE (e.g., using reception component 1102 and/or communication manager 1106, depicted in FIG. 11) may receive, over an unlicensed sidelink channel, multiple PSSCH transmissions associated with a PSFCH transmission occasion, wherein at least one PSFCH transmission in the PSFCH transmission occasion is in a shared COT, as described above.

As further shown in FIG. 10, in some aspects, process 1000 may include determining a minimum number of PSFCH transmissions to transmit in the PSFCH transmission occasion (block 1020). For example, the UE (e.g., using communication manager 1106, depicted in FIG. 11) may determine a minimum number of PSFCH transmissions to transmit in the PSFCH transmission occasion, as described above.

As further shown in FIG. 10, in some aspects, process 1000 may include selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT (block 1030). For example, the UE (e.g., using communication manager 1106, depicted in FIG. 11) may select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT, as described above.

As further shown in FIG. 10, in some aspects, process 1000 may include transmitting, over the unlicensed sidelink channel, the selected set of PSFCH transmissions in the PSFCH transmission occasion (block 1040). For example, the UE (e.g., using transmission component 1104 and/or communication manager 1106, depicted in FIG. 11) may transmit, over the unlicensed sidelink channel, the selected set of PSFCH transmissions in the PSFCH transmission occasion, as described above.

Process 1000 may include additional aspects, such as any single aspect or any combination of aspects described below and/or in connection with one or more other processes described elsewhere herein.

In a first aspect, the minimum number of PSFCH transmissions to transmit in the PSFCH transmission occasion is based at least in part on a PSFCH index associated with a PSFCH transmission that satisfies a condition for utilizing the shared COT.

In a second aspect, alone or in combination with the first aspect, the PSFCH transmission that satisfies the condition for utilizing the shared COT is a first PSFCH transmission, among the multiple scheduled PSFCH transmissions, that is in the shared COT.

In a third aspect, alone or in combination with one or more of the first and second aspects, the PSFCH transmission that satisfies the condition for utilizing the shared COT is a first PSFCH transmission, among the multiple scheduled PSFCH transmissions, that is in the shared COT and directed to a transmitting UE that initiated the shared COT.

In a fourth aspect, alone or in combination with one or more of the first through third aspects, the PSFCH transmission that satisfies the condition for utilizing the shared COT is a last PSFCH transmission, among the multiple scheduled PSFCH transmissions, that ensures that the selected set of PSFCH transmissions includes at least one in-COT PSFCH in each RB set associated with the shared COT.

In a fifth aspect, alone or in combination with one or more of the first through fourth aspects, the PSFCH transmission that satisfies the condition for utilizing the shared COT is a last PSFCH transmission, among the multiple PSFCH transmissions, that ensures that the selected set of PSFCH transmissions includes at least one in-COT PSFCH in each RB set associated with the shared COT that is directed to a transmitting UE that initiated the shared COT.

In a sixth aspect, alone or in combination with one or more of the first through fifth aspects, the minimum number of PSFCH transmissions to transmit in the PSFCH transmission occasion is a maximum value among a value of a parameter related to a maximum number of PSFCH transmissions that can be transmitted in the PSFCH occasion with a total transmission power that does not exceed a maximum transmit power constraint, and the PSFCH index associated with the PSFCH transmission that satisfies the condition for utilizing the shared COT.

In a seventh aspect, alone or in combination with one or more of the first through sixth aspects, selecting the set of PSFCH transmissions based at least in part on whether the scheduled PSFCH transmissions are in the shared COT or not includes selecting one or more PSFCH transmissions from a first set of scheduled PSFCH transmissions that are in the shared COT, and then selecting one or more PSFCH transmissions from a second set of scheduled PSFCH transmissions that are outside the shared COT based at least in part on a number of scheduled PSFCH transmissions associated with the PSFCH transmission occasion having a total transmission power that exceeds a maximum transmit power constraint.

In an eighth aspect, alone or in combination with one or more of the first through seventh aspects, selecting the one or more PSFCH transmissions from the first set of scheduled PSFCH transmissions that are in the shared COT is based on a primary criterion related to information carried in the scheduled PSFCH transmissions and a secondary criterion related to priority values associated with the scheduled PSFCH transmissions.

In a ninth aspect, alone or in combination with one or more of the first through eighth aspects, selecting the one or more PSFCH transmissions from the first set of scheduled PSFCH transmissions that are in the shared COT is based on a primary criterion related to types associated with one or more transmitting UEs intended to receive the scheduled PSFCH transmissions and a secondary criterion related to priority values associated with the scheduled PSFCH transmissions.

In a tenth aspect, alone or in combination with one or more of the first through ninth aspects, selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a priority value associated with the scheduled PSFCH transmissions.

In an eleventh aspect, alone or in combination with one or more of the first through tenth aspects, selecting the one or more PSFCH transmissions from the first set of scheduled PSFCH transmissions that are in the shared COT is based on a primary criterion related to types associated with one or more transmitting UEs intended to receive the scheduled PSFCH transmissions, a secondary criterion related to information carried in the scheduled PSFCH transmissions, and a tertiary criterion related to priority values associated with the scheduled PSFCH transmissions.

In a twelfth aspect, alone or in combination with one or more of the first through eleventh aspects, selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a primary criterion related to information carried in the scheduled PSFCH transmissions and a secondary criterion related to priority values associated with the scheduled PSFCH transmissions.

In a thirteenth aspect, alone or in combination with one or more of the first through twelfth aspects, selecting the one or more PSFCH transmissions from the second set of scheduled PSFCH transmissions that are outside the shared COT is based on a primary criterion related to information carried in the scheduled PSFCH transmissions and a secondary criterion related to priority values associated with the scheduled PSFCH transmissions.

In a fourteenth aspect, alone or in combination with one or more of the first through thirteenth aspects, selecting the set of PSFCH transmissions includes selecting, from a first subset of scheduled PSFCH transmissions that are in the shared COT, a first PSFCH transmission associated with a lowest priority value or an earliest slot within each RB set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.

In a fifteenth aspect, alone or in combination with one or more of the first through fourteenth aspects, selecting the set of PSFCH transmissions includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.

In a sixteenth aspect, alone or in combination with one or more of the first through fifteenth aspects, a number of PSFCH transmissions included in the set of PSFCH transmissions does not exceed a maximum number of simultaneous PSFCH transmissions supported by the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a responding UE, or a responding UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 8 and FIGS. 9A-9B. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the responding UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the responding UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the responding UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, over an unlicensed sidelink channel, multiple PSSCH transmissions associated with a PSFCH transmission occasion, wherein at least one PSFCH transmission in the PSFCH transmission occasion is in a shared COT. The communication manager 1106 may determine a minimum number of PSFCH transmissions to transmit in the PSFCH transmission occasion. The communication manager 1106 may select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT. The transmission component 1104 may transmit, over the unlicensed sidelink channel, the selected set of PSFCH transmissions in the PSFCH transmission occasion.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a responding UE, comprising: receiving, over an unlicensed sidelink channel, multiple PSSCH transmissions associated with a PSFCH transmission occasion, wherein at least one PSFCH transmission in the PSFCH transmission occasion is in a shared COT; determining a minimum number of PSFCH transmissions to transmit in the PSFCH transmission occasion; selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT; and transmitting, over the unlicensed sidelink channel, the selected set of PSFCH transmissions in the PSFCH transmission occasion.
Aspect 2: The method of Aspect 1, wherein the minimum number of PSFCH transmissions to transmit in the PSFCH transmission occasion is based at least in part on a PSFCH index associated with a PSFCH transmission that satisfies a condition for utilizing the shared COT.
Aspect 3: The method of Aspect 2, wherein the PSFCH transmission that satisfies the condition for utilizing the shared COT is a first PSFCH transmission, among the multiple scheduled PSFCH transmissions, that is in the shared COT.
Aspect 4: The method of Aspect 2, wherein the PSFCH transmission that satisfies the condition for utilizing the shared COT is a first PSFCH transmission, among the multiple scheduled PSFCH transmissions, that is in the shared COT and directed to a transmitting UE that initiated the shared COT.
Aspect 5: The method of Aspect 2, wherein the PSFCH transmission that satisfies the condition for utilizing the shared COT is a last PSFCH transmission, among the multiple scheduled PSFCH transmissions, that ensures that the selected set of PSFCH transmissions includes at least one in-COT PSFCH in each RB set associated with the shared COT.
Aspect 6: The method of Aspect 2, wherein the PSFCH transmission that satisfies the condition for utilizing the shared COT is a last PSFCH transmission, among the multiple PSFCH transmissions, that ensures that the selected set of PSFCH transmissions includes at least one in-COT PSFCH in each RB set associated with the shared COT that is directed to a transmitting UE that initiated the shared COT.
Aspect 7: The method of Aspect 2, wherein the minimum number of PSFCH transmissions to transmit in the PSFCH transmission occasion is a maximum value among: a value of a parameter related to a maximum number of PSFCH transmissions that can be transmitted in the PSFCH occasion with a total transmission power that does not exceed a maximum transmit power constraint, and the PSFCH index associated with the PSFCH transmission that satisfies the condition for utilizing the shared COT.
Aspect 8: The method of any of Aspects 1-7, wherein selecting the set of PSFCH transmissions based at least in part on whether the scheduled PSFCH transmissions are in the shared COT or not includes selecting one or more PSFCH transmissions from a first set of scheduled PSFCH transmissions that are in the shared COT, and then selecting one or more PSFCH transmissions from a second set of scheduled PSFCH transmissions that are outside the shared COT based at least in part on a number of scheduled PSFCH transmissions associated with the PSFCH transmission occasion having a total transmission power that exceeds a maximum transmit power constraint.
Aspect 9: The method of Aspect 8, wherein selecting the one or more PSFCH transmissions from the first set of scheduled PSFCH transmissions that are in the shared COT is based on a primary criterion related to information carried in the scheduled PSFCH transmissions and a secondary criterion related to priority values associated with the scheduled PSFCH transmissions.
Aspect 10: The method of Aspect 8, wherein selecting the one or more PSFCH transmissions from the first set of scheduled PSFCH transmissions that are in the shared COT is based on a primary criterion related to types associated with one or more transmitting UEs intended to receive the scheduled PSFCH transmissions and a secondary criterion related to priority values associated with the scheduled PSFCH transmissions.
Aspect 11: The method of Aspect 8, wherein selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a priority value associated with the scheduled PSFCH transmissions.
Aspect 12: The method of Aspect 8, wherein selecting the one or more PSFCH transmissions from the first set of scheduled PSFCH transmissions that are in the shared COT is based on a primary criterion related to types associated with one or more transmitting UEs intended to receive the scheduled PSFCH transmissions, a secondary criterion related to information carried in the scheduled PSFCH transmissions, and a tertiary criterion related to priority values associated with the scheduled PSFCH transmissions.
Aspect 13: The method of Aspect 8, wherein selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a primary criterion related to information carried in the scheduled PSFCH transmissions and a secondary criterion related to priority values associated with the scheduled PSFCH transmissions.
Aspect 14: The method of Aspect 8, wherein selecting the one or more PSFCH transmissions from the second set of scheduled PSFCH transmissions that are outside the shared COT is based on a primary criterion related to information carried in the scheduled PSFCH transmissions and a secondary criterion related to priority values associated with the scheduled PSFCH transmissions.
Aspect 15: The method of any of Aspects 1-14, wherein selecting the set of PSFCH transmissions includes selecting, from a first subset of scheduled PSFCH transmissions that are in the shared COT, a first PSFCH transmission associated with a lowest priority value or an earliest slot within each RB set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.
Aspect 16: The method of any of Aspects 1-15, wherein selecting the set of PSFCH transmissions includes selecting, from a first subset of scheduled PSFCH transmissions that are in the shared COT and directed to a transmitting UE that initiated the shared COT, a first PSFCH transmission associated with a lowest priority value or an earliest slot within each RB set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.
Aspect 17: The method of any of Aspects 1-16, wherein a number of PSFCH transmissions included in the set of PSFCH transmissions does not exceed a maximum number of simultaneous PSFCH transmissions supported by the UE.
Aspect 18: An apparatus for wireless communication at a device, comprising a processor; memory coupled with the processor; and instructions stored in the memory and executable by the processor to cause the apparatus to perform the method of one or more of Aspects 1-17.
Aspect 19: A device for wireless communication, comprising a memory and one or more processors coupled to the memory, the one or more processors configured to perform the method of one or more of Aspects 1-17.
Aspect 20: An apparatus for wireless communication, comprising at least one means for performing the method of one or more of Aspects 1-17.
Aspect 21: A non-transitory computer-readable medium storing code for wireless communication, the code comprising instructions executable by a processor to perform the method of one or more of Aspects 1-17.
Aspect 22: A non-transitory computer-readable medium storing a set of instructions for wireless communication, the set of instructions comprising one or more instructions that, when executed by one or more processors of a device, cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A method of wireless communication performed by a responding user equipment (UE), comprising:
receiving, over an unlicensed sidelink channel, multiple physical sidelink shared channel (PSSCH) transmissions associated with a physical sidelink feedback channel (PSFCH) transmission occasion, wherein at least one PSFCH transmission in the PSFCH transmission occasion is in a shared channel occupancy time (COT);
determining a minimum number of PSFCH transmissions to transmit in the PSFCH transmission occasion;
selecting, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT; and
transmitting, over the unlicensed sidelink channel, the selected set of PSFCH transmissions in the PSFCH transmission occasion.

2. The method of claim 1, wherein the minimum number of PSFCH transmissions to transmit in the PSFCH transmission occasion is based at least in part on a PSFCH index associated with a PSFCH transmission that satisfies a condition for utilizing the shared COT.

3. The method of claim 2, wherein the PSFCH transmission that satisfies the condition for utilizing the shared COT is a first PSFCH transmission, among the multiple scheduled PSFCH transmissions, that is in the shared COT.

4. The method of claim 2, wherein the PSFCH transmission that satisfies the condition for utilizing the shared COT is a first PSFCH transmission, among the multiple scheduled PSFCH transmissions, that is in the shared COT and directed to a transmitting UE that initiated the shared COT.

5. The method of claim 2, wherein the PSFCH transmission that satisfies the condition for utilizing the shared COT is a last PSFCH transmission, among the multiple scheduled PSFCH transmissions, that ensures that the selected set of PSFCH transmissions includes at least one in-COT PSFCH in each resource block (RB) set associated with the shared COT.

6. The method of claim 2, wherein the PSFCH transmission that satisfies the condition for utilizing the shared COT is a last PSFCH transmission, among the multiple PSFCH transmissions, that ensures that the selected set of PSFCH transmissions includes at least one in-COT PSFCH in each resource block (RB) set associated with the shared COT that is directed to a transmitting UE that initiated the shared COT.

7. The method of claim 2, wherein the minimum number of PSFCH transmissions to transmit in the PSFCH transmission occasion is a maximum value among:
a value of a parameter related to a maximum number of PSFCH transmissions that can be transmitted in the PSFCH occasion with a total transmission power that does not exceed a maximum transmit power constraint, and
the PSFCH index associated with the PSFCH transmission that satisfies the condition for utilizing the shared COT.

8. The method of claim 1, wherein selecting the set of PSFCH transmissions based at least in part on whether the scheduled PSFCH transmissions are in the shared COT or not includes selecting one or more PSFCH transmissions from a first set of scheduled PSFCH transmissions that are in the shared COT, and then selecting one or more PSFCH transmissions from a second set of scheduled PSFCH transmissions that are outside the shared COT based at least in part on a number of scheduled PSFCH transmissions associated with the PSFCH transmission occasion having a total transmission power that exceeds a maximum transmit power constraint.

9. The method of claim 8, wherein selecting the one or more PSFCH transmissions from the first set of scheduled PSFCH transmissions that are in the shared COT is based on a primary criterion related to information carried in the scheduled PSFCH transmissions and a secondary criterion related to priority values associated with the scheduled PSFCH transmissions.

10. The method of claim 8, wherein selecting the one or more PSFCH transmissions from the first set of scheduled PSFCH transmissions that are in the shared COT is based on a primary criterion related to types associated with one or more transmitting UEs intended to receive the scheduled PSFCH transmissions and a secondary criterion related to priority values associated with the scheduled PSFCH transmissions.

11. The method of claim 8, wherein selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each resource block (RB) set in the shared COT, and then selecting one or more PSFCH transmissions from a remaining subset of scheduled PSFCH transmissions according to a priority value associated with the scheduled PSFCH transmissions.

12. The method of claim 8, wherein selecting the one or more PSFCH transmissions from the first set of scheduled PSFCH transmissions that are in the shared COT is based on a primary criterion related to types associated with one or more transmitting UEs intended to receive the scheduled PSFCH transmissions, a secondary criterion related to information carried in the scheduled PSFCH transmissions, and a tertiary criterion related to priority values associated with the scheduled PSFCH transmissions.

13. The method of claim 8, wherein selecting the one or more PSFCH transmissions from the first set of scheduled PSFCH transmissions that are in the shared COT includes selecting, from a first subset of scheduled PSFCH transmissions that are in the shared COT and directed to a transmitting UE that initiated the shared COT, a first PSFCH transmission associated with a lowest priority value or an earliest slot within each resource block (RB) set in the shared COT, and then selecting one or more PSFCH transmissions from a remaining subset of scheduled PSFCH transmissions according to a primary criterion related to information carried in the scheduled PSFCH transmissions and a secondary criterion related to priority values associated with the scheduled PSFCH transmissions.

14. The method of claim 8, wherein selecting the one or more PSFCH transmissions from the second set of scheduled PSFCH transmissions that are outside the shared COT is based on a primary criterion related to information carried in the scheduled PSFCH transmissions and a secondary criterion related to priority values associated with the scheduled PSFCH transmissions.

15. The method of claim 1, wherein selecting the set of PSFCH transmissions includes selecting, from a first subset of scheduled PSFCH transmissions that are in the shared COT, a first PSFCH transmission associated with a lowest priority value or an earliest slot within each resource block (RB) set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.

16. The method of claim 1, wherein selecting the set of PSFCH transmissions includes selecting, from a first subset of scheduled PSFCH transmissions that are in the shared COT and directed to a transmitting UE that initiated the shared COT, a first PSFCH transmission associated with a lowest priority value or an earliest slot within each resource block (RB) set in the shared COT, and then selecting one or more PSFCH transmissions from a remaining subset of scheduled PSFCH transmissions according to a priority rule based at least in part on a number of scheduled PSFCH transmissions associated with the PSFCH transmission occasion having a total transmission power that exceeds a maximum transmit power constraint.

17. The method of claim 1, wherein a number of PSFCH transmissions included in the set of PSFCH transmissions does not exceed a maximum number of simultaneous PSFCH transmissions supported by the UE.

18. A responding user equipment (UE) for wireless communication, comprising:
a memory; and
one or more processors, coupled to the memory, configured to:
receive, over an unlicensed sidelink channel, multiple physical sidelink shared channel (PSSCH) transmissions associated with a physical sidelink feedback channel (PSFCH) transmission occasion, wherein at least one PSFCH transmission in the PSFCH transmission occasion is in a shared channel occupancy time (COT);
determine a minimum number of PSFCH transmissions to transmit in the PSFCH transmission occasion;
select, among multiple scheduled PSFCH transmissions associated with the PSFCH transmission occasion, a set of PSFCH transmissions that includes at least the minimum number of PSFCH transmissions based at least in part on whether the scheduled PSFCH transmissions are in the shared COT; and
transmit, over the unlicensed sidelink channel, the selected set of PSFCH transmissions in the PSFCH transmission occasion.

19. The responding UE of claim 18, wherein the minimum number of PSFCH transmissions to transmit in the PSFCH transmission occasion is based at least in part on a PSFCH index associated with a PSFCH transmission that satisfies a condition for utilizing the shared COT.

20. The responding UE of claim 19, wherein the PSFCH transmission that satisfies the condition for utilizing the shared COT is a first PSFCH transmission, among the multiple scheduled PSFCH transmissions, that is in the shared COT.

21-30. (canceled)
